(19) United States
(12) Patent Application Publication
(10) Pub. No.: US 2008/0313537 A1
(43) Pub. Date: Dec. 18, 2008

(54) DOCUMENT MANAGEMENT APPARATUS, DOCUMENT MANAGEMENT METHOD, AND PROGRAM

(75) Inventor: Satoshi Tanaka, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/137,488

(22) Filed: Jun. 11, 2008

(30) Foreign Application Priority Data
Jun. 12, 2007 (JP) 2007-155674

(51) Int. Cl. G06F 17/00

(52) U.S. Cl. 715/274; 715/277

(57) ABSTRACT

A method is described for displaying a preview image of a document in which a plurality of constituents is defined. The includes setting an authority for each user with respect to each constituent; displaying on a display device a content of at least one constituent as a preview image; designating a user for whom the preview image is displayed from among users whose authority is set; determining whether the designated user has an authority to display the content of the at least one constituent; and restricting display of a first portion of the content corresponding to each constituent for which the user is determined to have no authority and displaying a second portion of the content corresponding to each constituent for which the user is determined to have the authority. A document management apparatus for implementing the method is described which may be implemented, for example, using a computer.

### BACKGROUND OF THE INVENTION

1. Field of the Invention

The present invention relates to a document management apparatus configured to perform a preview of a document in which a plurality of constituents is defined, a document management method therefor, and a program that causes a computer to perform the document management method.

2. Description of the Related Art

In recent years, systems for viewing, editing, and printing an electronic document have been widely used. In the case where individual users or a small group of users use such a system, no serious problem may generally occur even when all the users view, edit, or print an electronic document.

However, in the case where an unspecified or a large number of users use such a system, various problems may arise because shared electronic documents and electronic documents that can be used only by specific users coexist within the system. Furthermore, it may be desired to allow all users to view and print electronic documents but restrict the editing of electronic documents to specific users only.

In order to address such problems, a conventional method sets a password to each electronic document and requests a user to enter the password to view the document. Another conventional method checks a type of authority of a user based on the entered password to allow an unauthorized user to view or print an electronic document but restrict the editing thereof.

Japanese Patent Application Laid-Open No. 2006-113664 discusses a system that sets a confidential portion in an electronic document. A specific user is allowed to view the confidential portion. Moreover, the system allows a user who requests to view the confidential portion to view the confidential portion if the user has viewing authority.

In the case of a system that can set an authority to view, edit, or print an electronic document in the unit of a page, for example, in addition to restricting the authority in the unit of a document, it is necessary for an administrator of an electronic document to perform a security setting for each page or user. Here, the term “security” refers to an authority to view or edit the document, for example. In this case, an administrator can easily verify whether a security is set for each page of an electronic document by referring to information displayed on each setting user interface (UI) for each page.

However, in order to verify the security setting, such as which user can view which page, an administrator needs to display and refer to the setting UIs for all the pages. Accordingly, in this case, a complicated operation for the authority verification may cause the administrator to overlook significant information.

The technique discussed in Japanese Patent Application Laid-Open No. 2006-113664 considers the security setting when a user views a document but does not consider convenience of an administrator in managing a document. That is, according to the technique discussed in Japanese Patent Application Laid-Open No. 2006-113664, in order to verify the security setting as to which user can view which page, an administrator needs to enter a user identification (ID) for each user to perform the verification.

Accordingly, the conventional method has a problem such that in the case where a security setting is set for each user for a constituent (for example, a page) of a document, it is necessary for an administrator to perform a complicated operation to verify the security setting status.

### SUMMARY OF THE INVENTION

The present invention is directed to a document management apparatus that can easily verify a status of a security setting for each user which is set for each constituent of a document and a method therefor.

According to an aspect of the present invention, a document management apparatus configured to display a preview image of a document in which a plurality of constituents are defined includes a setting unit configured to set an authority for each user with respect to each constituent, a display unit configured to display on a display device a content of at least one constituent as a preview image, a designation unit configured to designate a user for whom the preview image is displayed from among users whose authority is set by the setting unit, and a determination unit configured to determine whether the user designated by the designation unit has an authority to display the content of the at least one constituent, wherein the display unit restricts display of a first portion of the content corresponding to each constituent for which the user is determined to have no authority by the determination unit and displays a second portion of the content corresponding to each constituent for which the user is determined to have the authority by the determination unit.

According to an aspect of the present invention, an administrator can easily verify a status of a security setting for each user which is set to each constituent of a document. Thus, the management of a document can be performed with a high efficiency.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the designation, illustrate exemplary embodiments, features, and aspects of the invention and, together with the description, serve to explain the principles of the invention.

FIG. 1 illustrates an example software configuration of a document management system.

FIG. 2 illustrates an example hardware configuration of a digital computer (a document management apparatus).

FIGS. 3A and 3B illustrate an example format of a book file.

FIGS. 4A and 4B illustrate an example list of book attributes illustrated in FIGS. 3A and 3B.

FIG. 5 illustrates an example list of chapter attributes illustrated in FIGS. 3A and 3B.

FIG. 6 illustrates an example list of page attributes illustrated in FIGS. 3A and 3B.

FIG. 7 illustrates an example list of user information included in the book file illustrated in FIGS. 3A and 3B.

FIG. 8 illustrates an example list of a security attribute included in the book file illustrated in FIGS. 3A and 3B.

FIG. 9 is a flow chart illustrating an example of processing for opening a book file performed by a bookbinding application.

FIG. 10 is a flow chart illustrating an example detail flow of file opening processing for opening an existing book file, which is performed in step S902 in FIG. 9.

FIG. 11 is a flow chart illustrating an example flow of electronic original importing process.

FIG. 12 is a flow chart illustrating an example detail flow of electronic original generation processing in step S1101 in FIG. 11.

FIG. 13 illustrates an example UI screen displayed when a book file is newly generated.

FIG. 14 illustrates an example UI screen for displaying a designated book file from the existing files.

FIG. 15 illustrates an example UI screen for a user authentication.

FIG. 16 illustrates an example software configuration of a server-client type document management system, which is another example of the document management system.

FIG. 17 illustrates an example UI screen for changing a preview image based on a security setting for a designated user.

FIG. 18 illustrates an example UI screen for changing a preview image based on a security setting for a designated user.

FIG. 19 illustrates an example UI screen in which a preview image is changed based on a security setting for a designated user.

FIG. 20 illustrates an example UI screen displaying the setting related to a print appearance in the case where a preview image is changed based on a security setting for a designated user.

FIG. 21 illustrates an example UI screen in which a preview image is changed based on a setting related to the print appearance for a designated user.

FIG. 22 is a flow chart illustrating an example of processing for generating a user list to be displayed in a preview user selection combo box.

FIG. 23 is a flow chart illustrating an example of processing for generating a preview display image.

FIG. 24 is a flow chart illustrating an example detail flow of processing for generating a security-prioritized preview display image in step S2304 in FIG. 23.

FIG. 25 is a flow chart illustrating an example detail flow of processing for generating a preview image of a page N for a user A in step S2406 in FIG. 24.

FIG. 26 illustrates another example format of the book file.

FIG. 27 is a flow chart illustrating an example of processing for generating a preview display image.

FIG. 28 is a flow chart illustrating an example of processing for generating a preview display image in step S2704 in FIG. 27 which is performed based on a print attribute and a security setting for the designated user.

### DETAILED DESCRIPTION OF THE EXEMPLARY EMBODIMENTS

Various exemplary embodiments, features, and aspects of the present invention are described in detail below with reference to the drawings. The relative arrangement of the components, the numerical expressions, and numerical values set forth in these embodiments are not intended to limit the scope of the present invention unless it is specifically stated otherwise.

### First Exemplary Embodiment

A document management system according to a first exemplary embodiment of the present invention includes an electronic original writer which converts a data file generated by a general application into an electronic original file and a bookbinding application that provides a function for editing the electronic original file. The document management system is capable of generating and editing a document that includes generated data in a lump. The document management system can improve operability and efficiently edit a document.

Furthermore, the document management system is capable of adding a security setting (authority setting) to generated data. More specifically, the bookbinding application, which is described below, has functions for opening data having a security setting, adding a security setting to data, and generating data having a security setting.

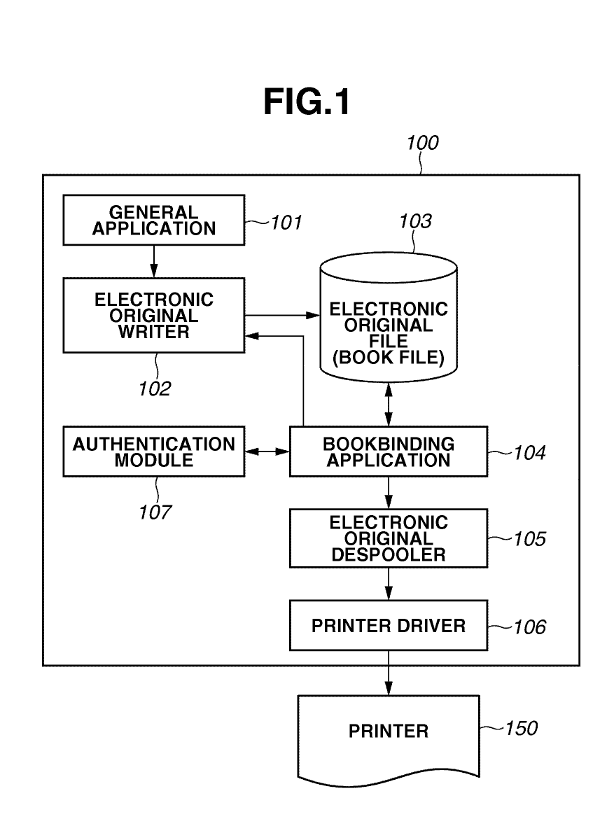

FIG. 1 illustrates an example software configuration of the document management system according to the present exemplary embodiment.

Referring to FIG. 1, the document management system includes a digital computer (host computer) 100 which is a document management apparatus of the present invention and a printer 150 which is a printing apparatus of the present invention. The digital computer 100 includes a general application 101, an electronic original writer 102, an electronic original file storage unit 103, a bookbinding application 104, an electronic original despooler 105, a printer driver 106, and an authentication module 107.

The general application 101 includes an application program that provides various functions, such as a word processing function, a spreadsheet function, a photo retouching function, a drawing function, a painting function, a presentation function, and a text editing function. In addition, the general application 101 has a print function used on an operating system (OS). The general application 101 utilizes a given interface provided by an OS (the interface is commonly called a graphic device interface (GDI)) in printing application data such as generated document data and image data.

The general application 101, in printing generated data, sends an output command which has a predetermined OS-dependent format (this command is called a “GDI function”) to an output module of the above-described OS that provides the interface. Meanwhile, upon receiving the output command, the output module converts the output command into a format which can be processed by an output device such as a printer, and then outputs the converted command (the command is called a “DDI function”).

The format which can be processed by an output device differs depending on a type, a manufacturer, and a model of the output device. Accordingly, a device driver is provided for each device. The OS converts the command utilizing the device driver to generate print data and combines the print data by a job language (JL) to generate a print job.

When the OS is Microsoft Windows®, a module called a graphic device interface (GDI) is an example of to the above-described output module.

The electronic original writer 102 is an improvement of the aforementioned device driver and is a software module provided to implement the document management system according to the present exemplary embodiment. However, the electronic original writer 102 is not intended for a specific output device. The electronic original writer 102 converts an output command into a format which can be processed by the bookbinding application 104 and the printer driver 106 (to be described below).

The format of the output command after the conversion by the electronic original writer 102 (hereinafter referred to as an “electronic original format”) can be configured in any format as long as an original can be expressed in a detailed form per page. As substantially standard formats, a portable document format (PDF) of Adobe Systems, Inc. and a scalable vector graphics (SVG) format can be employed as an electronic original format.

When the electronic original writer 102 is utilized from the general application 101, the electronic original writer 102 is designated as a device driver used for output before performing printing. However, an electronic original file generated by the electronic original writer 102 does not have a complete format as an electronic original file. Accordingly, the bookbinding application 104 specifies the electronic original writer 102 as a device driver. Under control of the bookbinding application 104, application data is converted into an electronic original file.

Then, the bookbinding application 104 completes an electronic original file having a format to be described below from an incomplete electronic original file newly generated by the electronic original writer 102. Hereinafter, in a case where it is necessary to clearly discriminate files, a file generated by the electronic original writer 102 is referred to as an “electronic original file”, and an electronic original file that is structured by the bookbinding application 104 is referred to as a “book file”. If it is not necessary to especially discriminate the files, both an electronic original file and a book file generated by an application are referred to as a “document file” (or “document data”).

As described above, the general application 101 prints data by designating the electronic original writer 102 as a device driver. As a result, the electronic original writer 102 converts application data into an electronic original format in the unit of one page defined by the general application 101 (hereinafter referred to as a “logical page” or an “original page”). The converted application data is stored as an electronic original file in the electronic original file storage unit 103 which includes a storage medium such as a hard disk. The electronic original file storage unit 103 can be configured of a local drive included in the digital computer 100 in the document management system according to the present exemplary embodiment. Furthermore, in a case where the document management system is connected to a network, the electronic original file storage unit 103 can be a drive provided on a network.

The bookbinding application 104 provides a user with a function for reading and editing an electronic original file (or a book file).

However, the bookbinding application 104 does not provide a function for editing a content of each page but a function for editing a structure of a chapter and a book handling one page as a minimum unit. When a book file edited by the bookbinding application 104 is printed, the electronic original despooler 105 is activated by the bookbinding application 104.

The electronic original despooler 105 is a program module installed in the digital computer 100 together with the bookbinding application 104. More specifically, the electronic original despooler 105 is a module used for outputting drawing data to the printer driver 106 in printing a document (book file) utilized by the bookbinding application 104.

The electronic original despooler 105 reads a designated book file from the electronic original file storage unit 103 and in order to print each page in a format described in the book file, generates an output command suitable to an output module of the OS, and then outputs the generated output command to an output module (not shown).

At this time, the printer driver 106 for the printer 150 that is used as an output device is designated as a device driver. The output module converts the output command received from the electronic original despooler 105 into a device command and outputs the device command to the designated printer driver 106 for the printer 150.

The printer driver 106 converts the device command output from the output module into a command in a page description language (PDL) that can be interpreted by the printer 150. The converted command is sent from the printer driver 106 to the printer 150 via a system spooler (not shown). Then, the printer 150 prints an image according to the received command.

The above-described processing is performed on an assumption that no security setting is set to an electronic original file (or a book file) stored on the electronic original file storage unit 103.

In the case where a security setting is set to an electronic original file (or a book file) stored on the electronic original file storage unit 103, the following processing is performed.

At first, the bookbinding application 104 acquires security information related to a security attribute, which is described below, from an electronic original file (or a book file). Then, the bookbinding application 104 sends the acquired security information to the authentication module 107 and waits for an authentication result.

The authentication module 107 displays an authentication dialog based on the security information received from the bookbinding application 104. A user enters an account name and a password via the authentication dialog. If the entered account name (user name) and password match the registered information, the authentication module 107 determines that the user has been successfully authenticated. Then, the authentication module 107 sends information that the user has been successfully authenticated and the authenticated user name to the bookbinding application 104.

If the entered user name is unregistered in the authentication module 107 or if a wrong password has been entered, then the authentication module 107 sends to the bookbinding application 104 information that the user is not authenticated.

According to the received information about a result of the authentication from the authentication module 107, if the user has been successfully authenticated by the authentication module 107, then the bookbinding application 104 performs the processing as in the case where no security setting is set to the document. On the other hand, if the user authentication by the authentication module 107 has failed, the bookbinding application 104 determines that the user is not authenticated and does not open the electronic original file (or the book file).

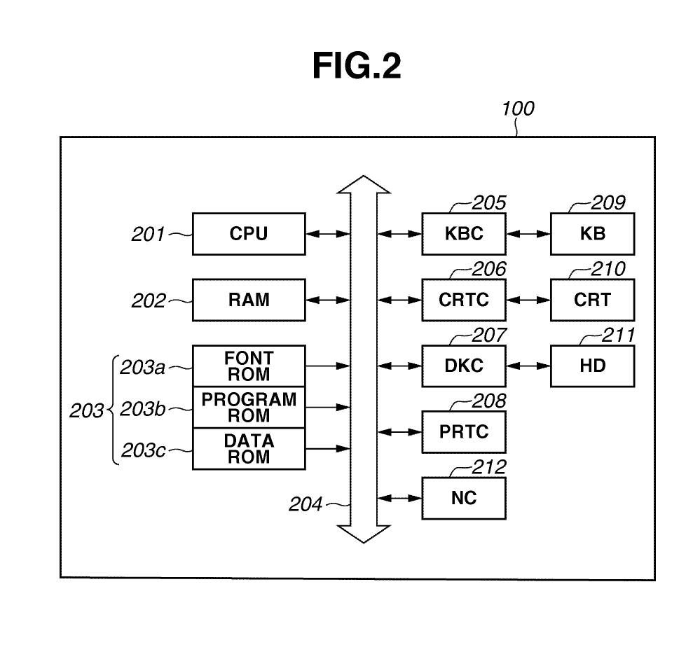

FIG. 2 is a block diagram illustrating an example hardware configuration of the digital computer (a document management apparatus) 100 according to the present exemplary embodiment.

In FIG. 2, a central processing unit (CPU) 201 executes programs such as the OS, the general application, and the bookbinding application which are stored on a program read-only memory (ROM) 203b of a ROM 203 or loaded from a hard disk (HD) 211 onto a random access memory (RAM) 202. The CPU 201 executes the programs to implement the software configuration illustrated in FIG. 1 and processing in flow charts, which are described below.

In the present exemplary embodiment, the CPU 201 and the program stored on the program ROM 203b or the HD 211 include the components 101, 102, and 104 to 107 in FIG. 1, for example. Furthermore, the HD 211, for example, includes the electronic original file storage unit 103 (FIG. 1).

The RAM 202 functions as a main memory and a work area of the CPU 201. The ROM 203 includes a font ROM 203a, the program ROM 203b, and a data ROM 203c, as its hardware configuration.

A keyboard controller (KBC) 205 controls a key input via a keyboard (KB) 209 and a pointing device (not shown). A cathode ray tube controller (CRTC) 206 controls a display on a CRT display 210. A disk controller (DKC) 207 controls an access to and from the HD 211 and a flexible disk (FD) (not shown) storing a boot program, various applications, font data, a user file, and an editing file, which is described below.

A printer controller (PRTC) 208 controls transmission and reception of signals to and from the printer 150 connected to the digital computer 100. A network controller (NC) 212 is connected to a network to control a communication with other apparatuses connected to the network.

A bus 204 connects the CPU 201, the RAM 202, the ROM 203, the KBC 205, the CRTC 206, the DKC 207, the PRTC 208, and the NC 212 which can mutually communicate with each other.

Before describing the bookbinding application 104 (FIG. 1) in detail, a format of data in a book file is described.

A book file includes a layer structure of multiple layers, which imitates a book made of a paper medium. A top layer is called a “book”, which imitates one book. In the top layer, an attribute related to the entire book is defined. An intermediate layer, which exists below the top layer, is equivalent to a chapter in a paper book and is called a “chapter”. The book may include one or more chapters, and for each chapter, an attribute can be defined.

A bottom layer is called a “page” and is equivalent to a page defined by the program of the general application 101. Each chapter may include one or more pages, and for each page an attribute can be defined. The totality of pages in the book represent a totality of pages defined by the program of the general application.

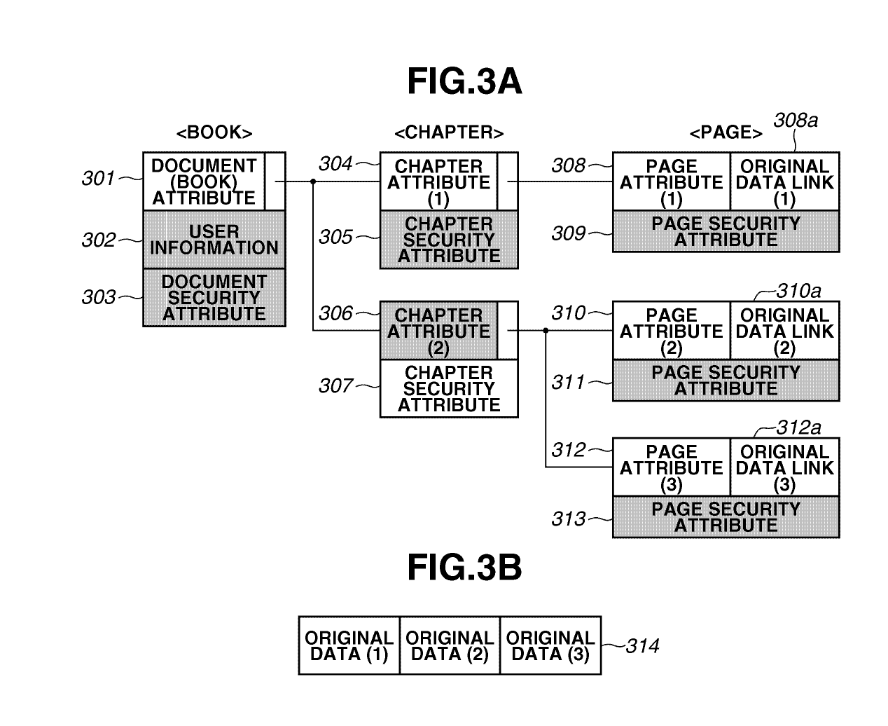

FIGS. 3A and 3B illustrate an example format of a book file.

FIG. 3A schematically illustrates an example format of a book file. As illustrated in FIG. 3A, in this example, each of a book, chapters, and pages in the book file is indicated by a node equivalent thereto. One book file includes one book.

A book and its chapters define a structure of a book file, and accordingly, include, as its substance, a value for a defined attribute and a link to the bottom layer. A page includes, as its substance, data of each page output by the general application 101.

Accordingly, a page includes, in addition to the attribute value, a substance of an original page (original data) and a link to the original data. There is a case where a print page that is output onto a paper medium includes a plurality of original pages. A structure in this case is not displayed by a link and is displayed as an attribute in each layer of a book, a chapter, and a page.

Referring to FIG. 3A, in a book, a book attribute (document attribute) 301 is defined and two chapters, namely, a chapter having a chapter attribute 304 and a chapter having a chapter attribute 306, are linked to the book. The link indicates that the book includes the chapter having a chapter attribute 304 and the chapter having a chapter attribute 306.

To the chapter having a chapter attribute 304, a page having a page attribute 308 is linked, and it is indicated that the chapter having a chapter attribute 304 includes the page having a page attribute 308. In the page attribute 308, an attribute value is defined. Furthermore, the page having the page attribute 308 includes a link 308a to original data (1), which is a substance of the original page.

Moreover, a page having a page attribute 310 and a page having a page attribute 312 are linked to the chapter having the chapter attribute 306, which indicates that the chapter having the chapter attribute 306 includes these pages. In each of the page attribute 310 and the page attribute 312, an attribute value is defined. Furthermore, the page having the page attribute 310 includes a link 310a to original data (2), which is a substance of the original page. The page having the page attribute 312 includes a link 312a to original data (3), which is a substance of the original page.

The link 308a, 310a, and 312a indicate the original data (1), the original data (2), and the original data (3) of original data 314, respectively, as illustrated in FIG. 3B. It is indicated that the substance of the page having the page attribute 308 is the original data (1), the substance of the page having the page attribute 310 is the original data (2), and the substance of the page having the page attribute 312 is the original data (3).

As illustrated in FIG. 3A, the book includes user information 302 about the document (book file) security setting and a document security attribute 303 for the document (book file).

Furthermore, each chapter includes a security attribute (a chapter security attribute 305 or a chapter security attribute 307) for each chapter. Moreover, each page includes a security attribute (a page security attribute 309, a page security attribute 311, and a page security attribute 313) for each page. The book file illustrated in FIG. 3A is stored in the electronic original file storage unit 103 (the HD 211).

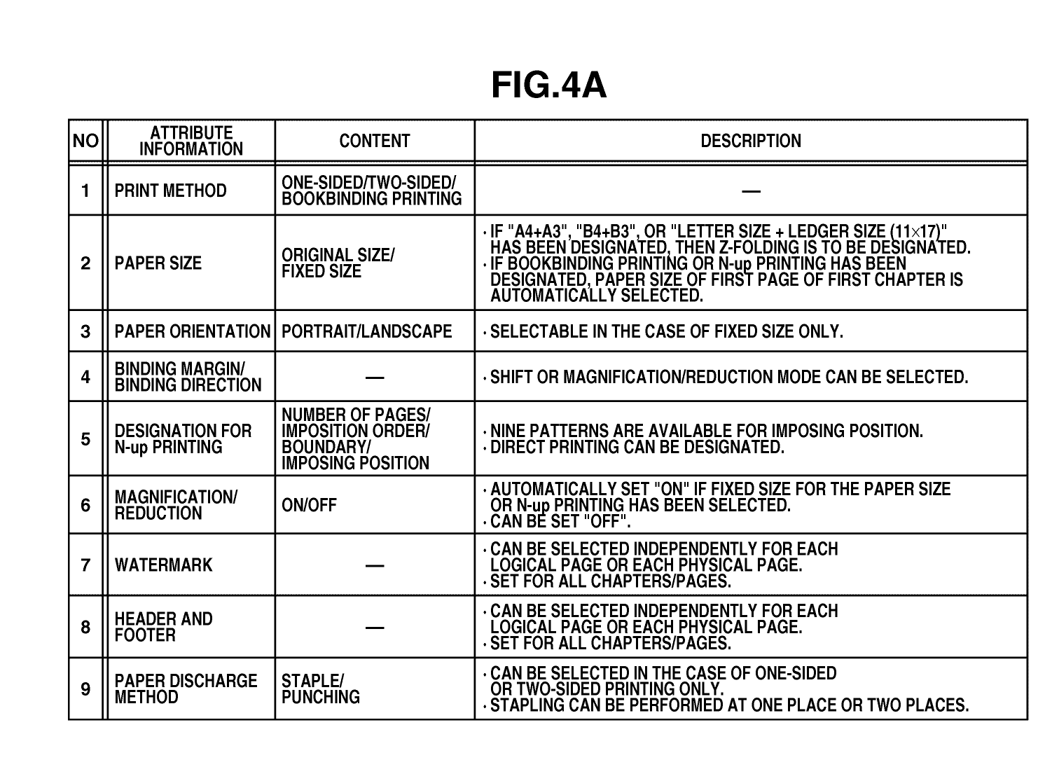

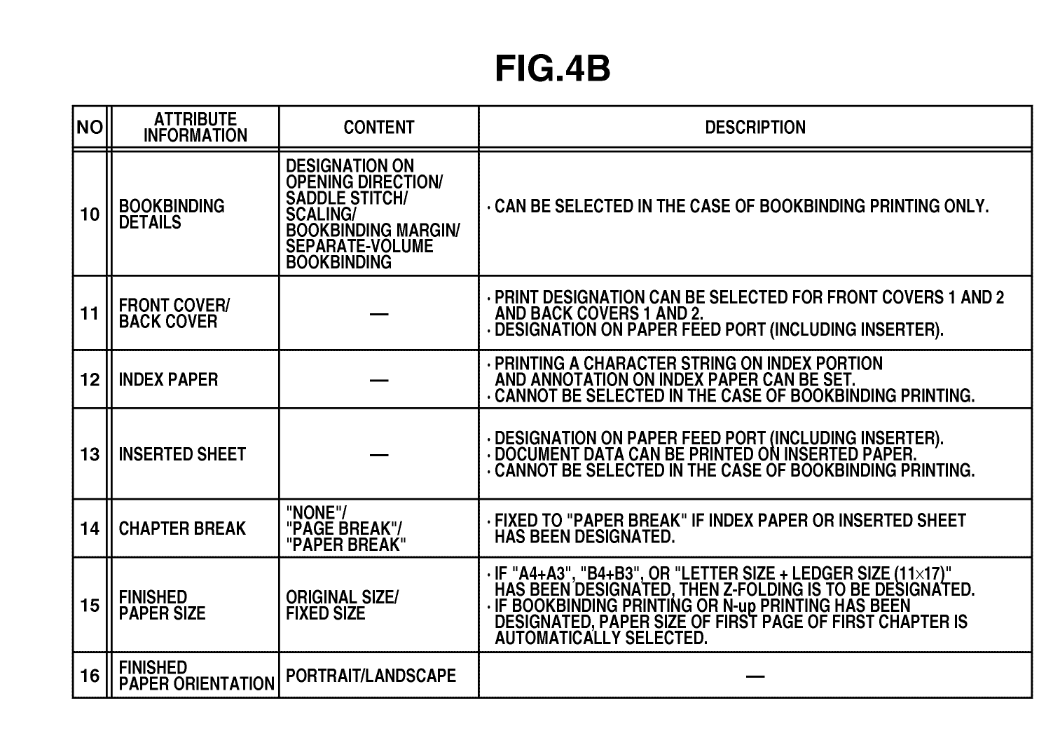

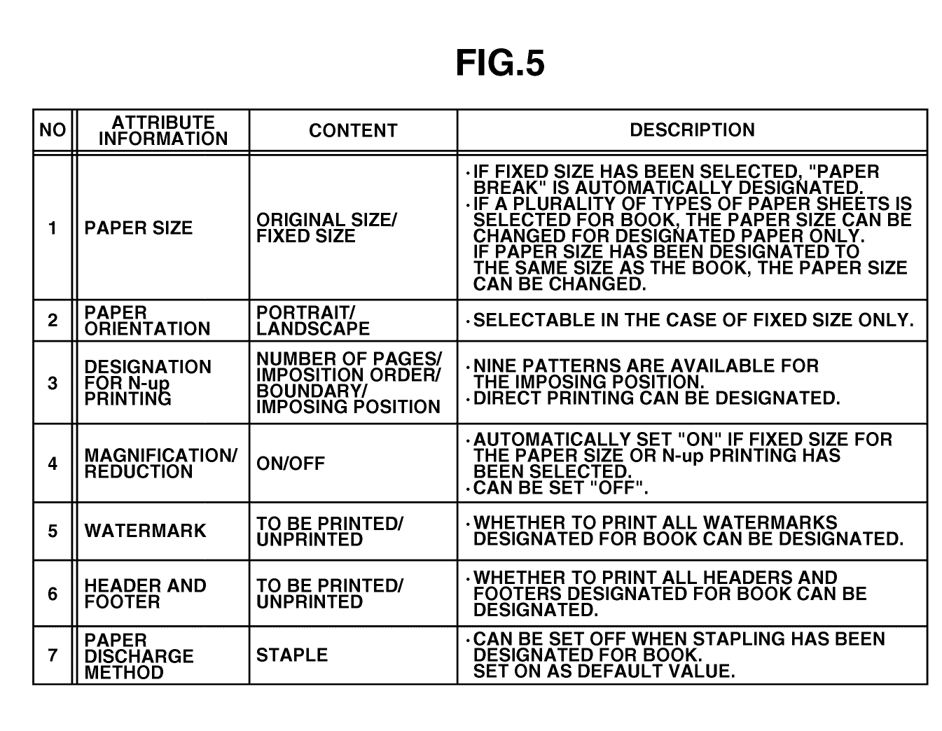

FIGS. 4A and 4B illustrate an example list of book attributes 301 illustrated in FIG. 3A. FIG. 5 illustrates an example list of chapter attributes (the chapter attributes 304 and 306) illustrated in FIG. 3A. FIG. 6 illustrates an example list of page attributes (the page attributes 308, 310, and 312) illustrated in FIG. 3A.

In the list of book attributes 301 in FIGS. 4A and 4B, for an item that can be defined and overlaps with an item in the lower layer, an attribute value for the lower layer may be used. Accordingly, as to an item included only in the book attribute 301, the value defined in the book attribute 301 becomes effective for the entire book.

However, the item overlapping with the lower layer represents a default value in the case where the item is not defined in the lower layer. Each item illustrated in FIGS. 4A and 4B does not specifically correspond to one item but can include a plurality of related items.

The relationship between a chapter attribute (the chapter attributes 304 and 306) and a page attribute (the page attributes 308, 310, and 312) is similar to the relationship between a book attribute (the book attribute 301) and an attribute in the lower layers.

As apparent from FIGS. 4A and 4b through 6, items unique to the book attribute 301 include eight items, namely, a print method, bookbinding details, front and back covers, an index paper, an inserted sheet, a chapter break, a finished paper size, and a finished paper orientation. These items are defined through the book.

As an attribute for the print method, three values, namely, one-sided printing, two-sided printing, and bookbinding printing can be designated. The bookbinding printing is a method in which printing is performed in a format capable of bookbinding by bundling a specified number of paper sheets, folding the bundle in two, and stitching the bundle.

For a detailed bookbinding attribute, when bookbinding printing is designated, a direction of a center-spread page and a number of pages to be bundled can be designated.

A front/back cover attribute includes a designation for adding sheets used for front and back covers in printing of an electronic original file that is bound as a book and a designation of a print content to the added sheet.

An index paper attribute includes a designation for inserting an index paper having a lug which is separately provided to a print apparatus (the printer 150) as a chapter break, and a designation of a print content to an index (lug) portion. The index paper attribute is effective when an inserter having a function for inserting a sheet that is provided separately from a print sheet in a desired position is provided to the printer 150 to be used or when a plurality of paper feed cassettes can be used. The same applies to an inserted sheet attribute.

The inserted sheet attribute includes a designation for inserting a sheet supplied from an inserter or a paper feed cassette as a chapter break and a designation of a paper feed source when the sheet is inserted.

A chapter break attribute includes a designation of whether a new sheet is used, a new print page is used, or nothing is specially done at a chapter break. In the case of one-sided printing, the use of a new sheet and the use of a new print page have a similar significance. In the case of two-sided printing, when “the use of a new sheet” is designated, successive chapters are not printed onto one sheet. However, when “the use of a new print page” is designated, successive chapters can be printed on both sides of one sheet.

A size attribute of finished paper and an orientation attribute of finished paper can be designated only when cutting processing is performed after print processing. A user can designate arrangement of an original image on an output paper sheet by the size attribute of finished paper and the orientation attribute of finished paper.

For a chapter attribute (FIG. 5), there is no item unique to a chapter and all the items overlap with the items for the book attribute (FIGS. 4A and 4B). Accordingly, if a definition in a chapter attribute differs from a definition in a book attribute, a value defined in the chapter attribute is preferentially used.

Items which are common only to the book attribute (FIGS. 4A and 4B) and the chapter attribute (FIG. 5) include five items, namely, a paper size, a paper orientation, a designation for N-up printing, magnification and reduction, and a paper discharge method.

Of these items, the N-up printing designation attribute is an item for designating the number of original pages included in one print page. N-up printing that can be designated includes 1×1, 1×2, 2×2, 3×3, and 4×4, for example. The paper discharge method attribute is an item for designating whether stapling processing is performed on discharged sheets. Effectiveness of the paper discharge method attribute depends on whether the printer 150 includes a stapling function.

In FIG. 6, items unique to the page attribute include a page rotation designation, zooming, an arrangement position, an annotation, and page division. The page rotation designation attribute is an item for designating a rotational angle for disposing an original page in a print page. The zooming attribute is an item for designating a magnification rate of an original page. The magnification rate is designated considering a size of a virtual logical page area as 100%.

The virtual logical page area is an area that one original page occupies when an original page is arranged according to a designation for N-up printing and the like. For example, when “1×1” is designated for the N-up printing, the virtual logical page area is equivalent to one print page. When “1×2” is designated for the N-up printing, the virtual logical page area is equivalent to an area reducing each side of one print page to 70%.

The book attributes (FIGS. 4A and 4B), the chapter attributes (FIG. 5), and the page attributes (FIG. 6) include, in common, a watermark attribute and a header and footer attribute.

A watermark includes, for example, an image and a character string, which are separately designated and printed overlapping with data generated by an application. The header and footer are a watermark printed respectively in a top margin and in a bottom margin of each page. However, for the header and the footer, an item that can be designated by a variable such as a page number and a date and time is provided.

The contents that can be designated in the watermark attribute and the header and footer attribute are common to the chapter attribute and the page attribute but are different in the book attribute. In the book attribute, the contents of the watermark attribute and the header and footer attribute can be set. In addition, in the book attribute, it can be designated how a watermark, a header, or a footer is printed through the entire book. Meanwhile, in the chapter attribute and the page attribute, it can be designated whether a watermark, a header, or a footer which is set in the book attribute is printed in a corresponding chapter and a page.

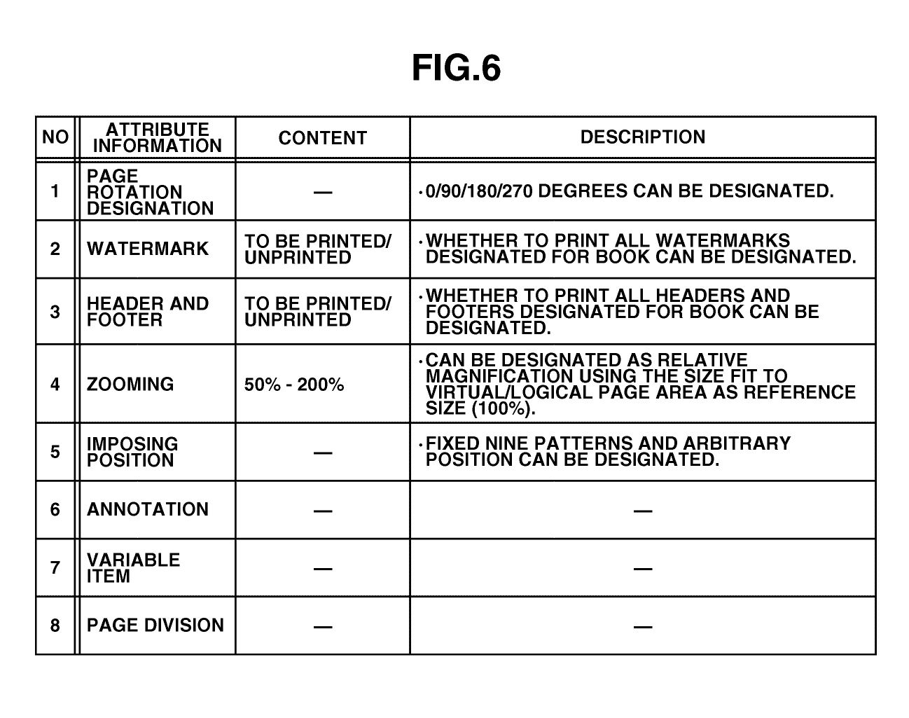

FIG. 7 illustrates an example list of the user information 302 included in the book file illustrated in FIG. 3A. As illustrated in a description column in FIG. 7, user information for one user includes a “user name”, a “password”, and information about “whether the user has an administrator authority”. The user information for all the users in the book file is managed as a list.

The bookbinding application 104 and the authentication module 107 perform a user authentication using the user information at the time of opening a book file or adding a new user. Among the users, an administrator who has every authority exists. Furthermore, an administrator authority can be set to a user. If an administrator authority is set to a user, the user has the same authority as the administrator.

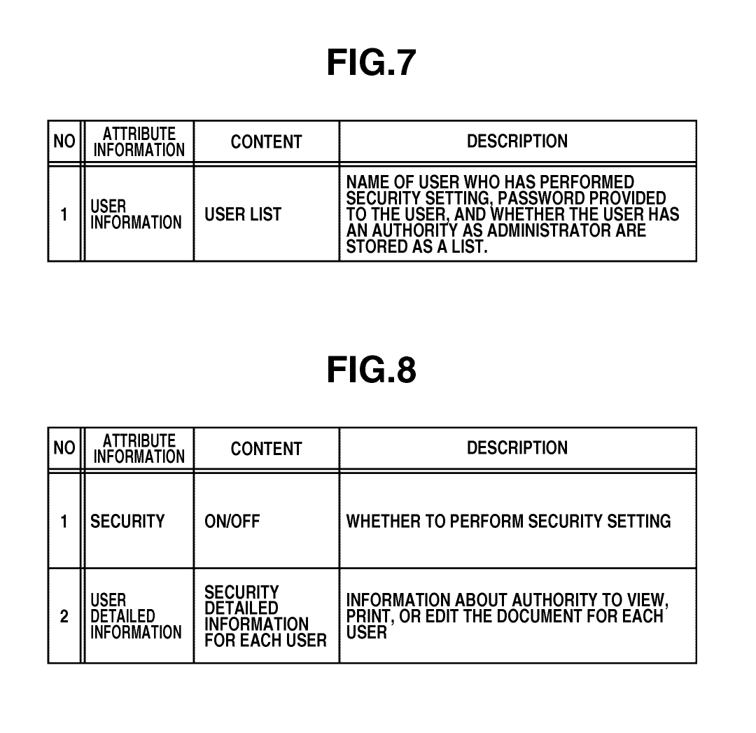

FIG. 8 illustrates an example list of a security attribute included in the book file (FIG. 3A).

Each security attribute (the security attributes 303, 305, 307, 309, 311, and 313 in FIG. 3A) for the book, the chapter, and the page has the same data structure. Information about the security attribute includes information about existence of a security setting which indicates whether the security is set, and detailed user information that indicates whether each user has a viewing authority, an editing authority, and a printing authority, as illustrated in FIG. 8.

The bookbinding application 104, using the detailed user information about the user who is authenticated by the authentication module 107, acquires the user's viewing authority, editing authority, or printing authority for each page, which is a constituent of a document file, and then sets the acquired user authority. The bookbinding application 104 implements the security for each page by determining whether the user can execute viewing, editing, or printing of each page based on the acquired user authority.

The bookbinding application 104 (the CPU 201) functions as a setting unit that performs a security setting with respect to each user for each page which is a constituent of a book file (document). A book file has the above-described structure and content.

Processing for generating a book file performed by the bookbinding application 104 and the electronic original writer 102 according to the present exemplary embodiment is described below. The book file generation processing is implemented as one part of a book file editing operation performed by the bookbinding application 104.

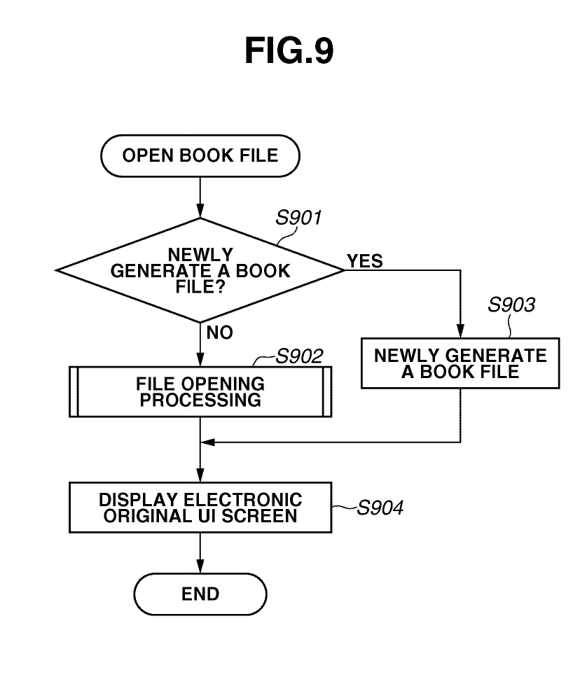

FIG. 9 is a flow chart illustrating an example of processing for opening a book file performed by the bookbinding application 104 (the CPU 201).

Referring to FIG. 9, in step S901, the bookbinding application 104 (the CPU 201) determines whether the book file to be opened is a file to be newly generated or an existing file. If it is determined that the book file to be opened is a file to be newly generated (YES in step S901), then the processing advances to step S903. In step S903, the bookbinding application 104 (the CPU 201) newly generates a book file that does not include a chapter.

The book file newly generated in step S903 includes, in the case of the example in FIG. 3A, only a node of a book which does not include a link to a node of a chapter. In this case, for the book attribute 301, a set of attributes that is previously prepared for newly generating a book is used.

In step S904, the CPU 201 performs control to display a UI screen for editing a newly generated book file on the CRT display 210 via the CRTC 206.

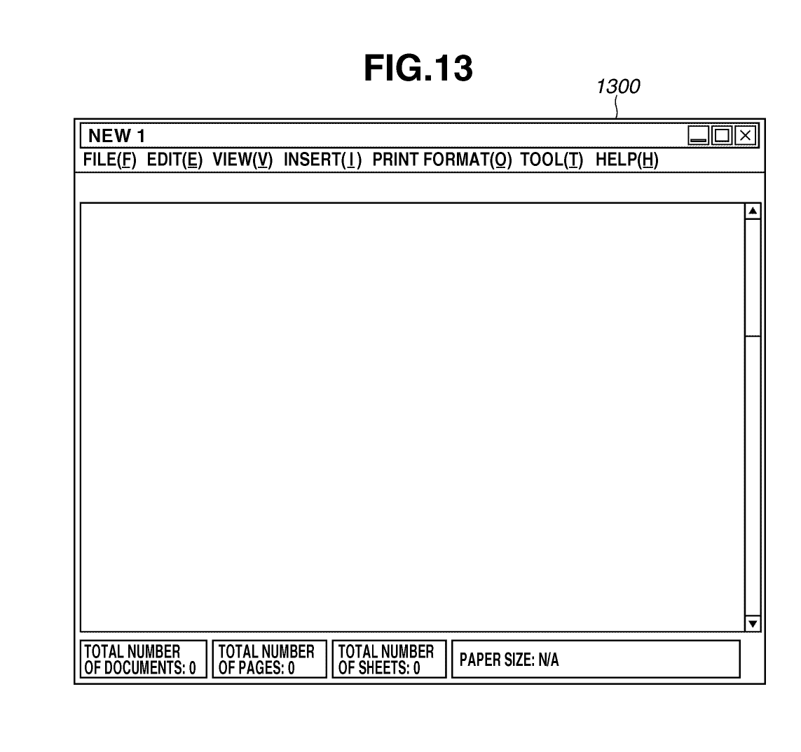

FIG. 13 illustrates an example UI screen displayed when a book file is newly generated. In this case, the book file has no substantial content. Accordingly, no content is displayed on a UI screen 1300.

On the other hand, if it is determined that the book file to be opened is not a file to be newly generated but an existing file (NO in step S901), then in step S902, the bookbinding application 104 (the CPU 201) opens the designated book file. Then, in step S904, the CPU 201 performs a control to display a UI screen on the CRT display 210 via the CRTC 206, based on the structure, attribute, and content of the designated book file.

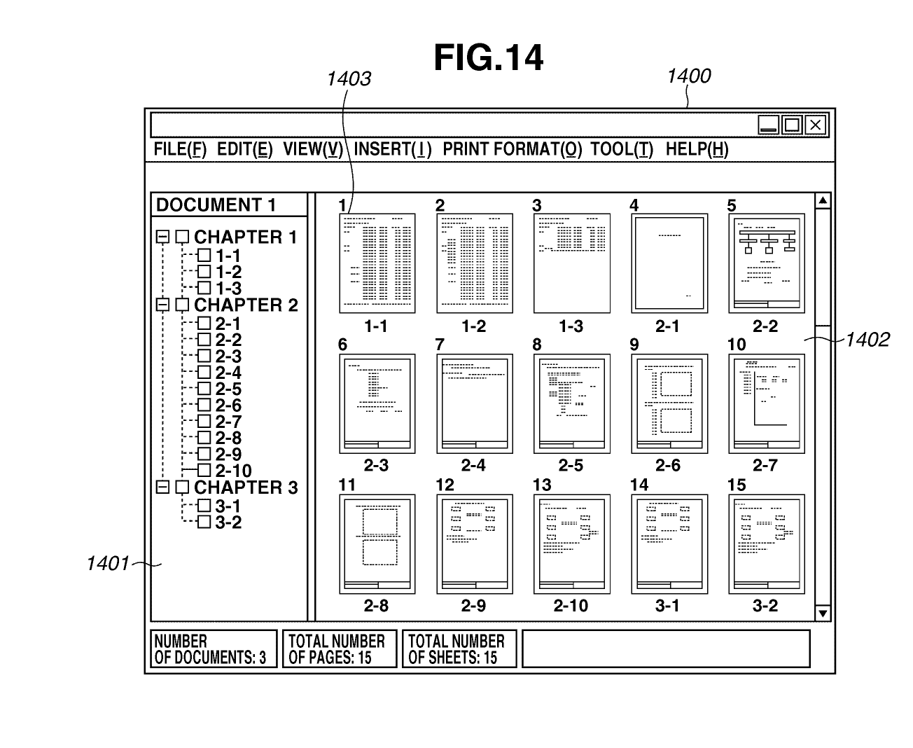

FIG. 14 illustrates an example UI screen for displaying the book file designated from the existing files.

Referring to FIG. 14, a UI screen 1400 includes a tree portion 1401 which indicates a structure of a book and a preview field 1402 which indicates a state of printing. In the tree portion 1401, chapters included in a book (chapters 1 through 3 in FIG. 14) and pages included in each chapter (pages 1-1 through 1-3 in chapter 1, pages 2-1 through 2-10 in chapter 2, and pages 3-1 and 3-2 in chapter 3 in FIG. 14) are displayed in a tree structure as illustrated in FIG. 3A.

The pages displayed in the tree portion 1401 are original pages. In addition, in the preview portion 1402, a content of a print page 1403 is displayed in a reduced state. The structure of the book is reflected in an order of displaying the chapters and the pages.

In the opened book file, application data which is converted into an electronic original file by the electronic original writer 102 (the CPU 201) can be added as a new chapter. This function is called an electronic original importing function.

When electronic original importing is performed on the book file newly generated according to the processing illustrated in FIG. 9, the book file is provided with a substance. The electronic original importing function is activated by drag-and-dropping the application data onto a screen illustrated in FIG. 13 (or FIG. 14).

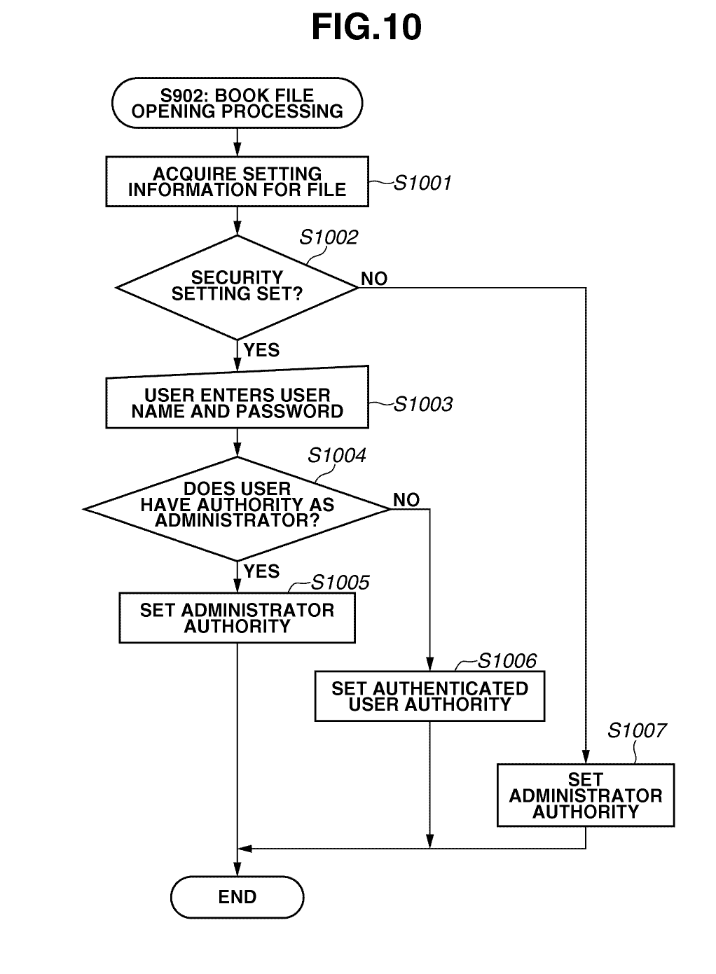

FIG. 10 is a flow chart illustrating an example detail flow of file opening processing for opening an existing file, which is performed in step S902 in FIG. 9.

Referring to FIG. 10, in step S1001, namely, at the start of the processing in step S902 in FIG. 9, the bookbinding application 104 (the CPU 201) acquires various setting information for the book file (FIG. 3A) from the electronic original file storage unit 103 (the HD 211).

In step S1002, the bookbinding application 104 (the CPU 201) determines whether a security setting is set in the various setting information for the book file acquired in step S1001. At this time, for example, the bookbinding application 104 (the CPU 201) determines whether a security setting is set in the security attribute of the book file.

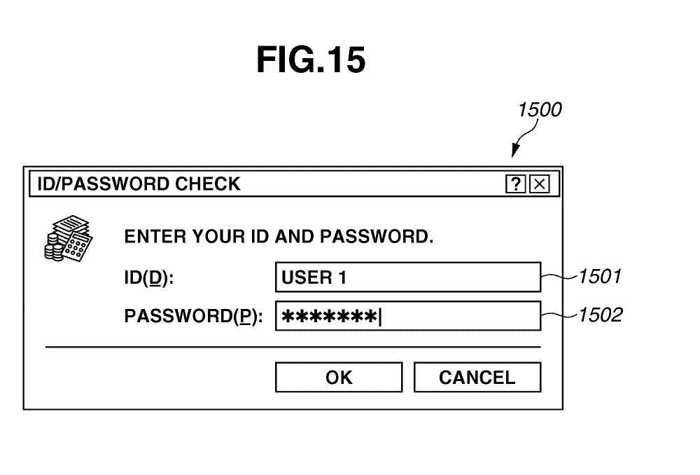

If it is determined that a security setting is set (YES in step S1002), then the CPU 201 (the authentication module 107) performs control so that a user authentication screen 1500 (FIG. 15) is displayed on the CRT display 210 via the CRTC 206. The user authentication screen 1500 (FIG. 15) includes a field 1501 for entering a user name and a field 1502 for entering a password.

In step S1003, the user enters the user name and the password in the user name entering field 1501 and the password entering field 1502, respectively. Then, the CPU 201 (the authentication module 107) detects the entered information and performs a user authentication.

In step S1004, the bookbinding application 104 (the CPU 201), based on the user information 302 (FIG. 3A) included in the book file, determines whether the user who is authenticated in step S1003 has an administrator authority.

If it is determined that the user has the administrator authority (YES in step S1004), then in step S1005, the bookbinding application 104 (the CPU 201) sets the administrator authority as an authority for opening the document (book file). In this case, the bookbinding application 104 (the CPU 201) opens the document (book file) based on the administrator authority.

On the other hand, if it is determined that the user has no administrator authority (NO in step S1004), then the processing advances to step S1006. In step S1006, the bookbinding application 104 (the CPU 201) sets the authority of the authenticated user as an authority for opening the document (book file). In this case, the bookbinding application 104 (the CPU 201) opens the document (book file) based on the user authority.

On the other hand, if it is determined that no security setting is set (NO in step S1002), then the document (book file) is provided with no security. In this case, in step S1007, the bookbinding application 104 (the CPU 201) sets an administrator authority to the user as an authority for opening the document (book file) in order to enable the user to perform the same operation as the administrator regardless of the user authentication. In this case, the bookbinding application 104 (the CPU 201) opens the document (book file) based on the administrator authority.

The processing flow of the above-described electronic original importing is described below.

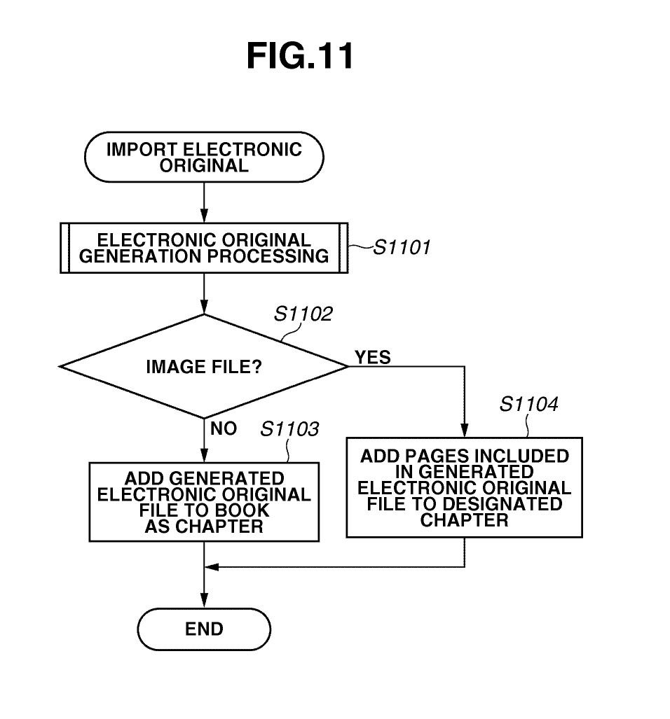

FIG. 11 is a flow chart illustrating an example flow of electronic original importing processing. Referring to FIG. 11, first, the bookbinding application 104 (the CPU 201) activates an application program that generates designated application data.

In step S1101, the bookbinding application 104 (the CPU 201) designates the electronic original writer 102 as a device driver and causes the electronic original writer 102 as a device driver to perform print processing on the application data and to convert the application data into an electronic original file (electronic original generation processing).

In step S1102, the bookbinding application 104 (the CPU 201) determines whether the generated electronic original file is an image file.

This determination in step S1102 is, in the case of using a Windows® OS, performed according to a file extension of the application data. For example, if the file extension is “bmp”, the application is determined as Windows® bitmap data. If the file extension is “jpg”, the application data is determined as joint photographic experts group (JPEG)-compressed image data. Furthermore, if the file extension is “tiff”, the application data is determined to be image data having a tag image file format (TIFF).

In the case where the application data is an image file, the processing in step S1101 can be omitted because an electronic original file can be generated directly from the image file without activating an application at the start of the processing in FIG. 11.

If it is determined that the generated electronic original file is not an image file (NO in step S1102), then the processing advances to step S1103.

In step S1103, the bookbinding application 104 (the CPU 201) adds the electronic original file generated in step S1101 to the book of the book file that is currently opened as a new chapter. For the chapter attribute (the chapter attributes 304 and 306 in FIG. 3A), with respect to an item in common with the book attribute 301 (FIG. 3A), the value in the book attribute is copied to the chapter attribute. The item that is not in common with the book attribute is set to a default value that is previously provided.

On the other hand, if it is determined in step S1102 that the generated electronic original file is an image file (YES in step S1102), then the processing advances to step S1104.

In step S1104, the bookbinding application 104 (the CPU 201), in principle, does not add a new chapter but adds each original page included in the electronic original file generated in step S1101 to the designated chapter. However, if the book file is a newly generated book file, the bookbinding application 104 (the CPU 201) generates a new chapter and adds each page of an electronic original file to the new chapter as a page included in the newly generated chapter.

With respect to the page attribute (the page attributes 308, 310, 312), items in common with the attribute in the upper layers are provided with an attribute value in the upper layers. With respect to the page attribute in which an attribute defined in the application data is transferred to the electronic original file, the value defined in the application data is provided. For example, in the case where an N-up printing designation is made in the application data, an attribute value thereof is transferred to the electronic original file. Thus, the bookbinding application 104 generates a new book file or adds a new chapter.

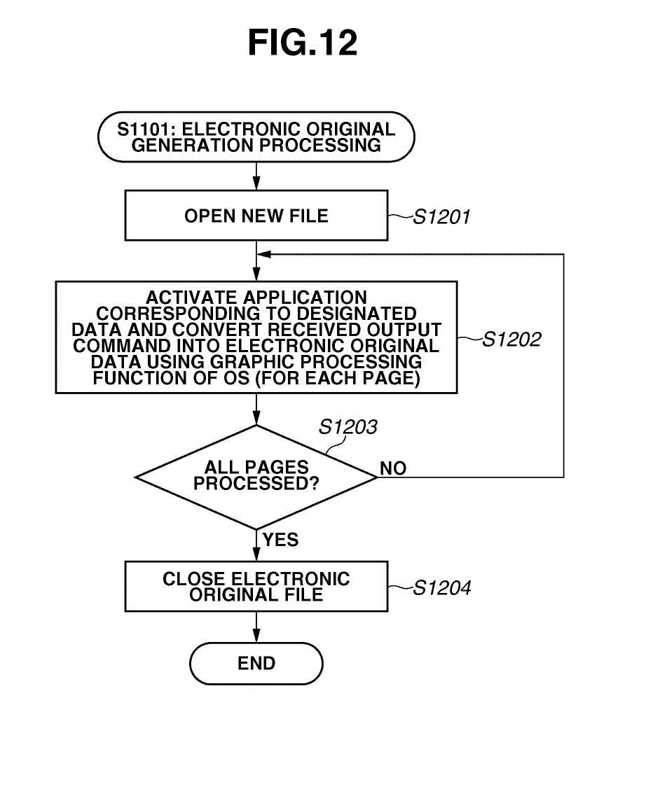

FIG. 12 is a flow chart illustrating an example detail flow of the electronic original generation processing in step S1101 in FIG. 11. The processing illustrated in FIG. 12 is performed by the electronic original writer 102 (the CPU 201).

Referring to FIG. 12, at the start of the processing in step S1101 (FIG. 11), in step S1201, the electronic original writer 102 (the CPU 201) generates and opens a new electronic original file.

In step S1202, the electronic original writer 102 (the CPU 201) activates an application corresponding to the designated application data. The electronic original writer 102 then sends an output command to an output module of the OS with the electronic original writer 102 as a device driver. The output module converts the received output command into electronic original format data per page using the electronic original writer 102 and then outputs the converted data. A destination of the output is the electronic original file that is opened in step S1201.

In step S1203, the electronic original writer 102 (the CPU 201) determines whether the conversion is completed for all the designated application data. If it is determined that the conversion is not completed for all the designated application data (NO in step S1203), then the processing returns to step S1202 to repeat the processing in step S1202.

On the other hand, if it is determined that the conversion is completed for all the designated application data (YES in step S1203), then in step S1204, the electronic original writer 102 (the CPU 201) closes the electronic original file.

The electronic original file generated by the electronic original writer 102 according to the processing in the flow chart of FIG. 12 is a file that includes original data 314 which is a substance of an original page illustrated in FIG. 3B.

As described above, a book file can be generated based on application data. With respect to the generated book file, the following editing operations can be performed on a chapter and a page of the book file.

(1) Add a new chapter (or page)

(2) Delete

(3) Copy

(4) Cut

(5) Paste

(6) Move

(7) Change a chapter name

(8) Rename and renumber a page

(9) Insert a cover

(10) Insert a slip sheet (inserted sheet)

(11) Insert an index sheet

(12) Provide a page layout to each original page

In addition, an editing operation that has once been performed can be canceled, and the canceled operation can be re-performed. With these editing functions, editing operations can be performed such as combining a plurality of book files, rearranging chapters and pages in a book file, deleting a chapter or a page in a book file, changing a layout of an original page, and insertion of a sheet to be inserted or an index sheet.

By performing these operations, a result of the operation can be reflected on the attributes illustrated in FIGS. 4A and 4B and FIG. 5 or on a structure of a book file. For example, when an operation for newly adding a blank page is performed, a blank page is inserted in a designated position. The inserted blank page is handled as an original page.

In addition, by changing a layout of an original page, the content of the change is reflected on the attributes such as the print method, the N-up printing, the front/back covers, the index paper, the inserted sheet, and the chapter break. The editing operations cannot be performed if a user having no editing authority with respect to the designated book, chapter, or page has been authenticated.

In addition, a security setting can be performed. By using a security setting, a viewing authority, an editing authority, or a printing authority of each user can be set for the entire book file or in the unit of a chapter or a page. The result of the security setting is reflected in the security attribute in FIG. 8. Furthermore, a new user can be set via the setting screen at the same time. The user who is newly set is added to the user information in FIG. 7. In addition, a function for adding or deleting a user is separately provided.

The book file, which is generated and edited as described above, is intended to be finally printed out. When a user selects a file menu via the UI screen 1400 in FIG. 14 and selects printing, the book file is printed out by a designated output device.

In the print processing, first, the bookbinding application 104 generates a job ticket based on the book file that is currently opened and then transfers the generated job ticket to the electronic original despooler 105. The electronic original despooler 105 converts the received job ticket into an output command of the OS (for example, a GDI function in Windows®) and then sends the output command to an output module (for example, to a GDI). The output module generates a command suitable to the output device using the designated printer driver 106 and then sends the generated command to the output device.

A job ticket is data having a structure that uses an original page as a minimum unit. The structure of a job ticket defines a layout of an original page on a sheet. One job ticket is issued for one job. Accordingly, a document node exists in a top portion of a job ticket, and in this portion, an attribute for the entire document such as an attribute for two-sided printing or one-sided printing is defined. Just below the document node, a paper node exists, which includes an identifier of a paper to be used and a designation of a paper discharge port in a printer 150.

Each paper node includes a node of a sheet printed with the paper. One sheet is equivalent to one paper. Each sheet includes a print page (physical page). In the case of one-sided printing, one sheet includes one physical page. In the case of two-sided printing, one sheet includes two physical pages. Each physical page includes an original page that is disposed thereon. In addition, an attribute for a physical page includes a layout of an original page.

The electronic original despooler 105 converts the above-described job ticket into an output command to be sent to an output module. The above-described printing operation cannot be performed if a user having no printing authority for the book is authenticated.

The document processing system illustrated in FIG. 1 is a stand-alone type system. However, a server-client system, which is an expansion of the stand-alone system, can generate and edit a book file with a substantially similar configuration and processing. However, in this case, a book file and print processing are managed by a server apparatus.

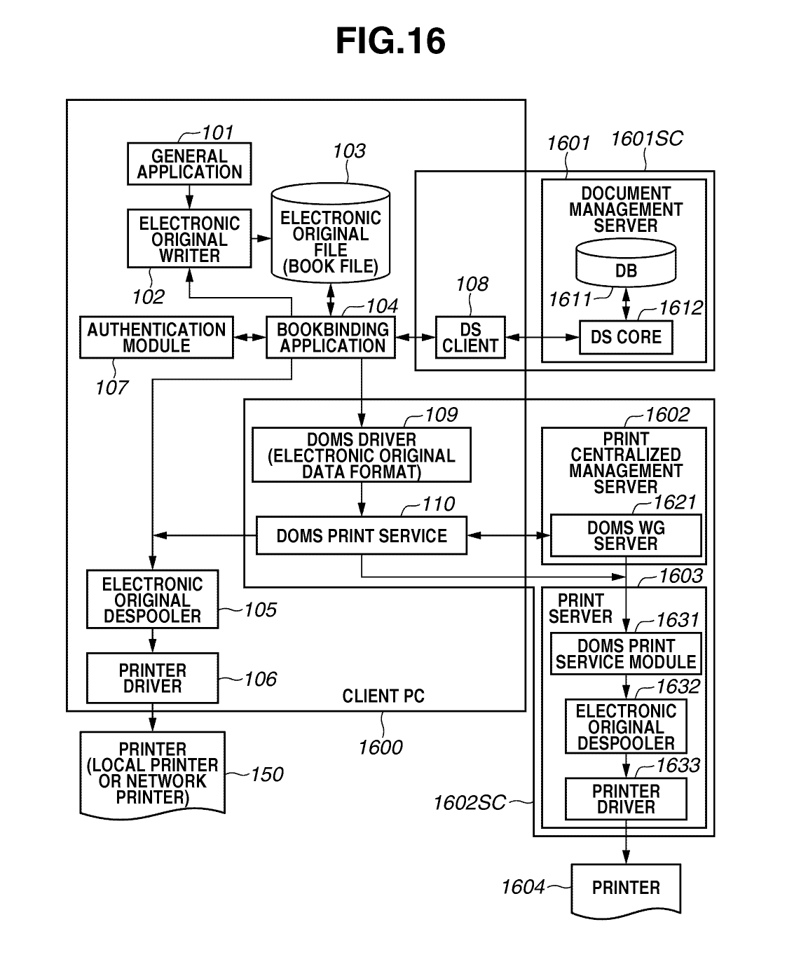

FIG. 16 illustrates another example of the document management system according to the present exemplary embodiment of the present invention. More specifically, FIG. 16 illustrates an example software configuration of a server-client type document management system. Referring to FIG. 16, a client personal computer (PC) 1600 corresponds to the document management apparatus according to the present exemplary embodiment.

The client PC 1600 includes a document service (DS) client module 108, a document output management service (DOMS) driver 109, and a DOMS print service module 110, in addition to the components of the digital computer 100 illustrated in FIG. 1.

In the client PC 1600, the CPU 201 (FIG. 2) and the program stored on the program ROM 203b (FIG. 2) or the HD 211 (FIG. 2) implement each of the components in FIG. 16 (the general application 101, the electronic original writer 102, the bookbinding application 104, the electronic original despooler 105, the printer driver 106, the authentication module 107, the DS client module 108, the DOMS driver 109, and the DOMS print service module 110), for example. Furthermore, the HD 211, for example, implements the electronic original file storage unit 103 (FIG. 16).

In the document management system illustrated in FIG. 16, a document management server 1601, a print centralized management server 1602, and a print server 1603 are connected to the client PC 1600. Furthermore, a printer 1604 is connected to the print server 1603. The document management server 1601, the print centralized management server 1602, and the print server 1603 are connected to the client PC 1600 via an ordinary network. In the case where a server functions as a client at the same time, the server is connected via an inter-process communication in which a communication between networks is simulated.

In the example illustrated in FIG. 16, both the print centralized management server 1602 and the print server 1603 are connected to the client PC 1600. However, one of the print centralized management server 1602 and the print server 1603 may exist on a network. In this case, for example, if the document management server 1601 is connected to the client PC 1600, a document management server-client system 1601SC including the DS client module 108 is provided.

Furthermore, if the print centralized management server 1602 is connected to the client PC 1600, the print management server-client system 1602SC including the DOMS driver 109, the DOMS print service module 110, and the print server 1603 is provided.

The document management server 1601 is a server that stores a book file generated and edited by the bookbinding application 104. In the case of managing a book file with the document management server 1601, the book file is stored in a database (DB) 1611 of the document management server 1601 instead of or in addition to the electronic original file storage unit 103 in the client PC 1600.

Storing and reading of a book file between the bookbinding application 104 and the document management server 1601 are performed via the DS client module 108 and a DS core 1612.

The print centralized management server 1602 is a server that manages printing of a book file stored in the client PC 1600 or in the document management server 1601. A print request generated by the client PC 1600 is sent to a DOMS WG server module 1621 of the print centralized management server 1602 via the DOMS driver 109 and the DOMS print service module 110.

The print centralized management server 1602, in the case where printing is performed by the printer 150 connected to the client PC 1600, sends a book file to the electronic original despooler 105 via the DOMS print service module 110.

In the case of printing with the printer 1604 connected to the print server 1603, the print centralized management server 1602 sends a book file to a DOMS print service module 1631 in the print server 1603. In this case, the printer 1604 prints the book file via an electronic original despooler 1632 and a printer driver 1633 in the print server 1603.

The print centralized management server 1602 performs security checking concerning an authority of a user who issues a print request of the stored book file and stores a log file of the print processing, for example. As described above, the document processing system can be implemented in a stand-alone system or in a client-server system.

As described above, when a book file is opened by the bookbinding application 104 (the CPU 201), the UI screen 1400 illustrated in FIG. 14 is displayed.

In the tree portion 1401, a tree indicating a structure of the opened book (hereinafter referred to as a “target book”) is displayed. In the preview portion 1402, three display methods are provided according to a designation by a user. At this time, the user performs the designation via the KB 209 (FIG. 2).

A first display method is a mode called an original view in which an original page is displayed as it is. In the original view mode, a content of the original page included in the target book is displayed in a reduced state. A layout is not reflected on the display in the preview portion 1402.

A second display method is a print view mode. In the print view mode, an original page is displayed in the preview portion 1402 in a state in which a layout of an original page is reflected.

A third display method is a simple print view mode In the simple print view mode, a content of each original page is not reflected on the display in the preview portion 1402, and only the layout of the original page is reflected.

In the case where the security setting is performed for the book file and if the user has no administrator authority at the time of opening the book file, the content of the display in the preview is restricted according to the security setting. In this case, with respect to the page for which the authenticated user has no viewing authority, the content of the original page is not displayed, or alternatively, a dummy page image which indicates that the current user has not viewing authority is displayed as a preview display image.

A document management system according to a second exemplary embodiment of the present invention is described next.

### Second Exemplary Embodiment

According to the second exemplary embodiment, a method is provided for displaying a preview according to a security setting set for each user in the case where a security setting is set for each page (each constituent) constituting one book file (document).

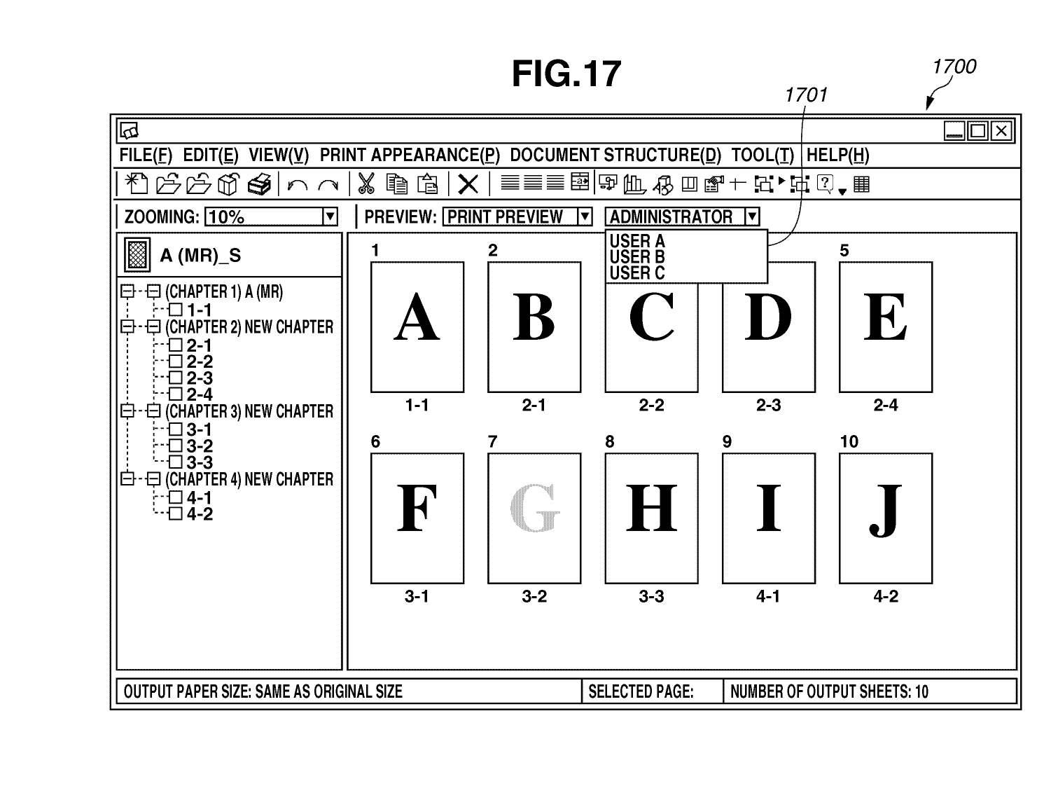

In the present exemplary embodiment, a UI screen 1700 is used which includes a preview user selection combo box 1701 (FIG. 17) in addition to the UI screen 1400 in FIG. 14 which is opened by the bookbinding application 104. By using the preview user selection combo box 1701, a user who is a target of a preview can be designated.

In the case where the user authenticated for the book file has an administrator authority, the preview user selection combo box 1701 displays a list of all users who is registered in the opened book file.

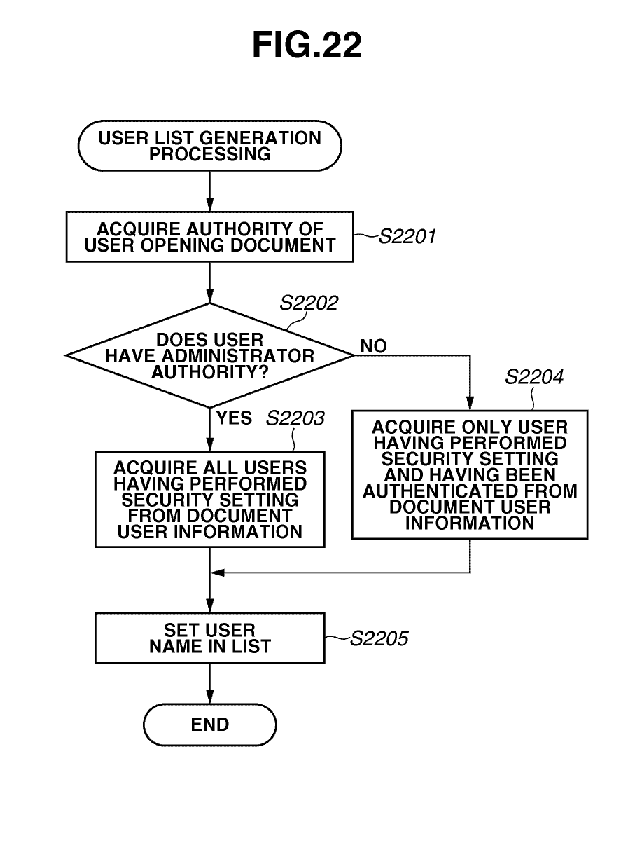

On the other hand, in the case where the user authenticated for the book file has no administrator authority, the preview user selection combo box 1701 displays a list of the authenticated user only. The processing for generating the list is performed according to the processing for generating user list in the flow chart of FIG. 22, which is described below.

Furthermore, the preview user selection combo box 1701 can display a list of not only individual users but also user groups which include a plurality of users in a lump.

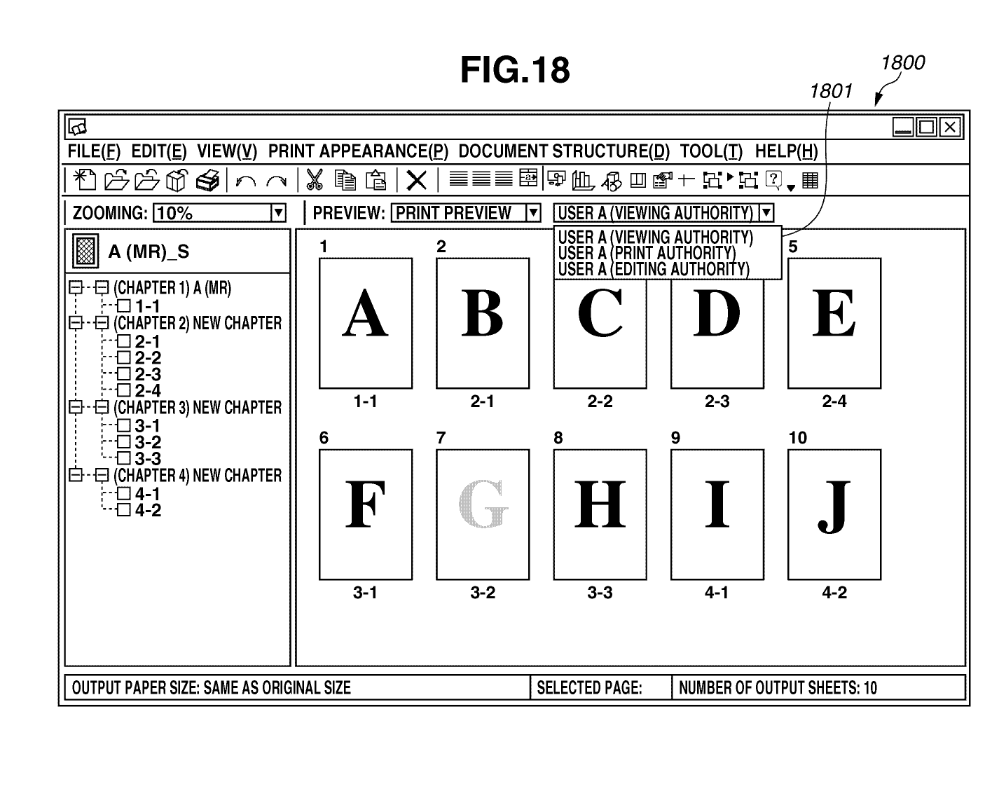

In addition, as illustrated by a preview user selection combo box 1801 on a UI screen 1800 (FIG. 18), the name and authority of each user can be displayed at the same time as a list. The example of the preview user selection combo box 1701 (FIG. 17) is based on the assumption that the user has a viewing authority. On the other hand, in the example of the preview user selection combo box 1801 (FIG. 18), the preview is performed based on the selected authority of the user.

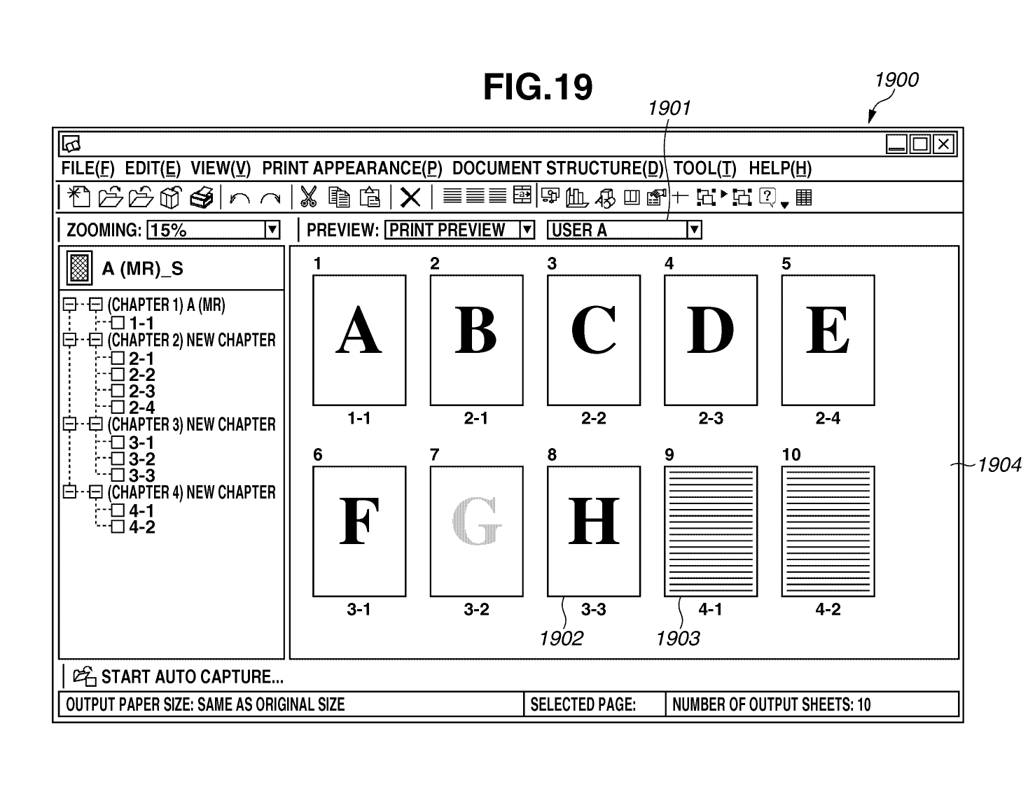

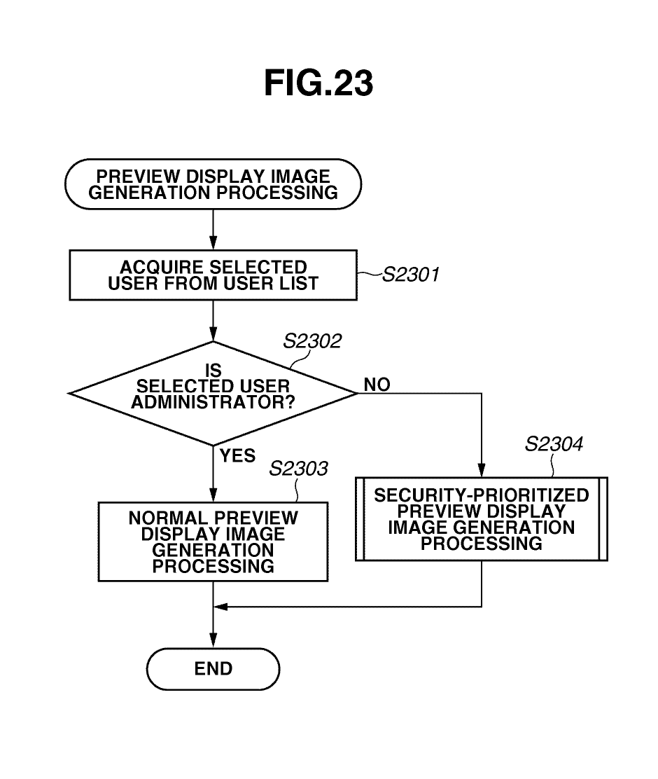

As illustrated by a preview user selection combo box 1901 on a UI screen 1900 in FIG. 19, in the case where a “user A” is selected as the user for whom a preview is performed, a preview is displayed in a preview portion 1904 according to the authority of the user A. Processing for generating a preview display image is performed according to the processing in flow charts of FIGS. 23 through 25, which are described below.

By generating a preview display image as described above, the page for which the user A has the viewing authority is displayed as a preview in which the content thereof can be recognized as a page 1902 in FIG. 19. A page 1903 in FIG. 19 for which the user A does not have the viewing authority is displayed as a preview in which the content thereof cannot be recognized.

In generating a paper sheet preview image, if an attribute that concerns a page layout is set to a book, a chapter, or a page, then the page layout is generated based on the attribute. In this case, the paper sheet preview image according to the authority of the selected user is displayed.

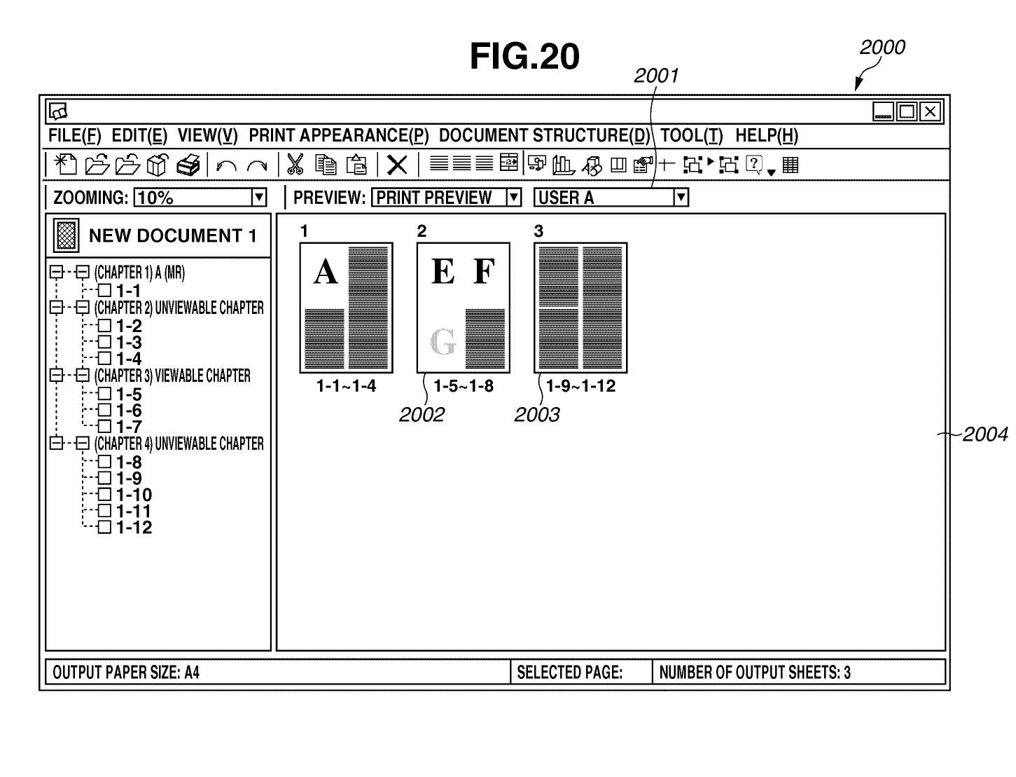

FIG. 20 illustrates an example UI screen displayed when an attribute for arranging four pages on one paper sheet is set and a preview is performed based on the authority of the user A.

Referring to FIG. 20, on a UI screen 2000, an output paper sheet preview image for print processing when the user A is selected and designated via a preview user selection combo box 2001 is displayed on a preview portion 2004. A preview image of a paper sheet 2002 includes a fifth, a sixth, a seventh, and an eighth pages. However, because the user A has the authority only for a first, the fifth, the sixth, and the seventh pages, the paper sheet 2002 is displayed as a preview image in which the content of the eighth page cannot be recognized.

In the case where the user does not have any authority for all the pages to be printed on one output paper sheet, the paper sheet preview is displayed as a preview image in which the contents of all the pages to be printed on the output paper sheet cannot be recognized, as shown in the image of a paper sheet 2003 in FIG. 20.

In print processing, a page and an output paper sheet for which a user has no printing authority are printed according to the preview image in which the content thereof cannot be recognized. However, the present exemplary embodiment can be applied to a configuration that prevents printing of a page or an output paper sheet for which the user does not have a printing authority according to selection by the user. In addition, the present invention can be applied in the case where an operation similar to the present exemplary embodiment is performed by storing information about a security setting outside the data structure, namely, on a security management server connected to the document management system via a network, instead of including the information related to a security setting in the data structure, as in FIG. 3A.

Processing for generating a user list to be displayed in the preview user selection combo box is described below.

FIG. 22 is a flow chart illustrating an example of processing for generating a user list to be displayed in the preview user selection combo box. This processing starts immediately before processing for displaying a user list like the preview user selection combo box 1701 in FIG. 17 by the bookbinding application 104.

Referring to FIG. 22, in step S2201, the bookbinding application 104 (the CPU 201) acquires the authority of the user authenticated in the processing for opening the book file (document) from the user information 302 of the book file in FIG. 3A.

In step S2202, the bookbinding application 104 (the CPU 201) determines whether the user authority acquired in step S2201 includes an administrator authority.

If it is determined that the user authority acquired in step S2201 includes an administrator authority (YES in step S2202), then the processing advances to step S2203. In step S2203, the bookbinding application 104 (the CPU 201) acquires information (e.g., the user name) about all the users registered in the user information 302 (all the users for whom a security setting is set) from the user information 302.

On the other hand, if it is determined that the user authority acquired in step S2201 does not include an administrator authority (NO in step S2202), then the processing advances to step S2204. In step S2204, the bookbinding application 104 (the CPU 201) acquires information (e.g., the user name) only about the authenticated user for whom a security setting is set from the user information 302.

After the processing in step S2203 or step S2204 is completed, the processing advances to step S2205. In step S2205, the bookbinding application 104 (the CPU 201) generates a user list by setting the user names acquired in step S2203 or step S2204 in the list, and then the user list generation processing ends.

In the present exemplary embodiment, when generating a list of users for whom a security setting is set, the bookbinding application 104 (the CPU 201) generates only a list of selected users instead of generating a list of all the users for whom a security setting is set. Furthermore, the bookbinding application 104 (the CPU 201) can generate a list of users based on a type of the security setting set for each user.

Processing for generating a preview display image is described below.

FIG. 23 is a flow chart illustrating an example of the processing for generating a preview display image according to the second exemplary embodiment. The processing starts before the bookbinding application 104 (the CPU 201) opens a new book file and actually performs a preview or at the time the bookbinding application 104 (the CPU 201) generates a page preview image due to a change in a print attribute.

Referring to FIG. 23, in step S2301, the bookbinding application 104 (the CPU 201) acquires information about the user who is selected and designated via the preview user selection combo box.

In step S2302, the bookbinding application 104 (the CPU 201), based on the user information 302, determines whether the user whose user information 302 has been acquired in step S2301 is an administrator having an administrator authority.

If it is determined that the user whose user information 302 has been acquired in step S2301 is the administrator having the administrator authority (YES in step S2302), then the processing advances to step S2303. In step S2303, the bookbinding application 104 (the CPU 201) performs processing for generating a normal preview display image for normally displaying all the page preview images and then completes the processing.

On the other hand, if it is determined that the user whose user information 302 has been acquired in step S2301 is not the administrator having the administrator authority (NO in step S2302), then the processing advances to step S2304. In step S2304, the bookbinding application 104 (the CPU 201), based on the security setting set for the user, performs processing for generating a security-prioritized preview display image, and then completes the processing.

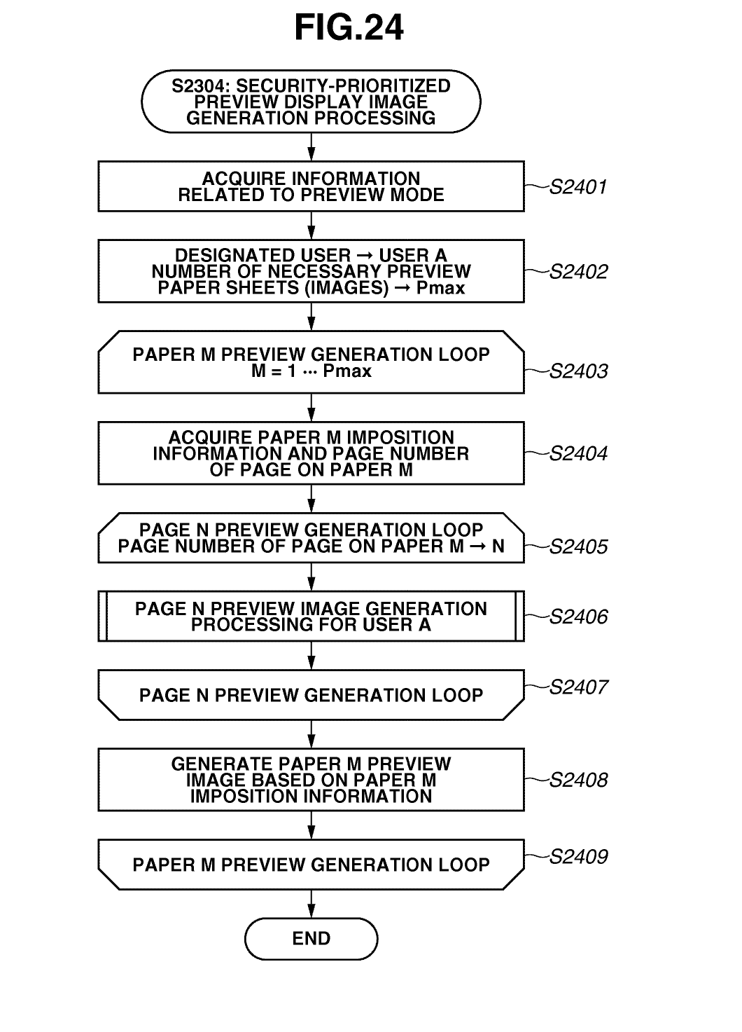

FIG. 24 is a flow chart illustrating an example detail flow of the processing for generating the security-prioritized preview display image in step S2304 in FIG. 23.

At the start of the processing in step S2304 in FIG. 23, in step S2401, the bookbinding application 104 (the CPU 201) acquires information about a preview mode, namely, information about the processing for generating the preview display image in step S2304.

In step S2402, the bookbinding application 104 (the CPU 201) sets (stores) the user who is selected via the preview user selection combo box as the user A and sets (stores) a number of necessary paper sheet preview images (number of images) as a value Pmax based on the information about the preview mode acquired in step S2401 and the print attribute.

In step S2403, the bookbinding application 104 (the CPU 201) sets a variable M indicating a paper sheet preview image to be generated. Thus, a paper sheet M corresponding to the paper sheet preview image to be generated is set and a loop for generating a preview image for the paper sheet M starts. In first processing, “1” is set to the paper sheet M.

In step S2404, the bookbinding application 104 (the CPU 201) acquires information about imposition on the paper sheet M to be generated and acquires page number(s) of page(s) to be imposed on the paper sheet M.

In step S2405, the bookbinding application 104 (the CPU 201) sets a variable N indicating a page preview image to be generated. Thus, a page N corresponding to the page preview image to be generated is set and a loop for generating a preview image for the page N on the paper sheet M starts. In first processing, a smallest page number of the acquired page numbers is set to the page N.

In step S2406, the bookbinding application 104 (the CPU 201) performs the processing for generating a preview image for the page N based on the authority of the user A. Then, the processing advances to step S2407.

In step S2407, the bookbinding application 104 (the CPU 201) determines whether processing for generating the preview image is completed for all the pages having the page number acquired in step S2404. If it is determined in step S2407 that a page whose processing for generating the preview image is not performed yet exists in the pages having the page number acquired in step S2404, then the processing returns to step S2405. In step S2405, the bookbinding application 104 (the CPU 201) changes the page N to be generated. Then, the bookbinding application 104 (the CPU 201) repeats the processing in step S2406.

On the other hand, if it is determined in step S2407 that the processing for generating the preview image is completed for all the pages having the page number acquired in step S2404, then the processing advances to step S2408. In step S2408, the bookbinding application 104 (the CPU 201) generates the preview image for the paper sheet M using the preview image of each page acquired in the loop in steps S2405 through S2407, information about the preview mode for the paper sheet M, and the print attribute.

In step S2409, the bookbinding application 104 (the CPU 201) determines whether the processing for generating preview image is completed for all the paper sheets having the value Pmax set in step S2402. If it is determined in step S2409 that a page whose processing for generating preview image is not completed exists, then the processing returns to step S2403. In step S2403, the bookbinding application 104 (the CPU 201) increments the paper sheet M to be generated by one and performs the setting for changing the paper sheet M to be generated. Then, the bookbinding application 104 (the CPU 201) repeats the processing in step S2404 and subsequent steps.

On the other hand, if it is determined in step S2409 that the processing for generating preview is completed for all the paper sheets having the value Pmax set in step S2402, then the bookbinding application 104 (the CPU 201) generates a security-prioritized preview display image based on all the generated paper sheet preview image. Then, the processing in the flow chart of FIG. 24 ends.

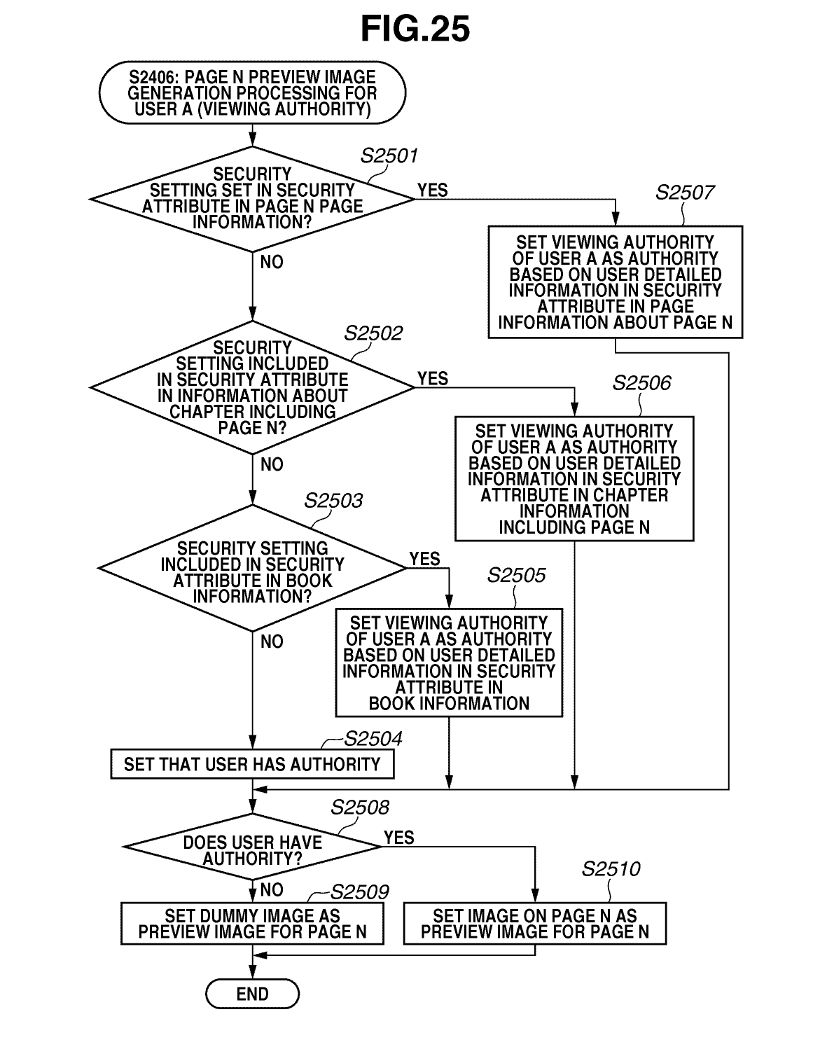

FIG. 25 is a flow chart illustrating an example detail flow of processing for generating a preview image for the page N for the user A in step S2406 in FIG. 24. The processing performed by the bookbinding application 104 (the CPU 201) in the case where a viewing authority is set as the security setting is described below.

At the start of the processing in step S2406 in FIG. 24, in step S2501, the bookbinding application 104 (the CPU 201) determines whether a security setting is set in the security attribute in the page information for the page N. The security attribute for the page N corresponds to the security attributes (the page security attributes 309, 311, and 313) for the page in FIG. 3A.

If it is determined that no security setting is set in the security attribute in the page information for the page N (NO in step S2501), then the processing advances to step S2502. In step S2502, the bookbinding application 104 (the CPU 201) determines whether a security setting is set in the security attribute in the chapter information for the chapter including the page N. The security attribute for the chapter including the page N corresponds to the security attributes (the chapter security attributes 305 and 307) for the chapter in FIG. 3A.

If it is determined that no security setting is set in the security attribute in the chapter information for the chapter including the page N (NO in step S2502), then the processing advances to step S2503. In step S2503, the bookbinding application 104 (the CPU 201) determines whether a security setting is set in the security attribute in the book information for the book including the page N. The security attribute for the book including the page N corresponds to the security attribute 303 for the book (document) in FIG. 3A.

If it is determined that no security setting is set in the security attribute in the book information for the book including the page N (NO in step S2503), then the processing advances to step S2504.

In step S2504, because no security setting is set in all the security attributes for the page N, the chapter including the page N, and the book including the page N, the bookbinding application 104 (the CPU 201) performs a setting that the user A has an authority (the viewing authority).

On the other hand, if it is determined that a security setting is set in the security attribute in the book information for the page N (YES in step S2503), then the processing advances to step S2505. In step S2505, the bookbinding application 104 (the CPU 201) sets the viewing authority for the user A as the authority based on the user detailed information (FIG. 8) in the book security attribute.

More particularly, in step S2505, if the viewing authority of the user A is set in the detailed user information in the book security attribute, then the bookbinding application 104 (the CPU 201) performs a setting that the user A has the authority, while if the viewing authority of the user A is not set in the detailed user information in the book security attribute, then the bookbinding application 104 (the CPU 201) performs a setting that the user A does not have the authority.

On the other hand, if it is determined in step S2502 that a security setting is set in the security attribute in the chapter information for the chapter including the page N (YES in step S2502), then the processing advances to step S2506. In step S2506, the bookbinding application 104 (the CPU 201) sets the viewing authority of the user A as the authority based on the user detailed information (FIG. 8) in the security attribute for the chapter including the page N.

In step S2506, if the viewing authority of the user A is set in the detailed user information in the security attribute for the chapter including the page N, then the bookbinding application 104 (the CPU 201) performs a setting that the user A has the authority, while if the viewing authority of the user A is not set in the user detailed information in the security attribute for the chapter including the page N, then the bookbinding application 104 (the CPU 201) performs a setting that the user A does not have the authority.

On the other hand, if it is determined in step S2501 that a security setting is set in the security attribute in the page information for the page N (YES in step S2501), then the processing advances to step S2507. In step S2507, the bookbinding application 104 (the CPU 201) sets the viewing authority of the user A as the authority based on the user detailed information (FIG. 8) in the security attribute for the page N.

In step S2507, if the viewing authority of the user A is set in the user detailed information in the security attribute for the page N, then the bookbinding application 104 (the CPU 201) performs a setting indicating that the user A has the authority, while if the viewing authority of the user A is not set in the detailed user information in the security attribute for the page N, then the bookbinding application 104 (the CPU 201) performs a setting indicating that the user A does not have the authority.

After the processing in steps S2504, S2505, and S2506 or S2507 are completed, the processing advances to step S2508. In step S2508, the bookbinding application 104 (the CPU 201) determines whether the user A has the authority (the viewing authority) for the page N.

If it is determined in step S2508 that the user A does not have the authority (the viewing authority) for the page N (NO in step S2508), then the processing advances to step S2509. In step S2509, because the user A has no authority for the page N, the bookbinding application 104 (the CPU 201) sets a dummy image as the preview image for the page N in which the content cannot be recognized and then ends the processing for generating a preview image for the page N for the user A. Thereby, if it is determined in step S2508 that the user A does not have the authority (the viewing authority) for the page N (NO in step S2508), then the display of the page N which is a constituent of the document is restricted.

On the other hand, if it is determined in step S2508 that the user A has the authority (the viewing authority) for the page N (YES in step S2508), then the processing advances to step S2510. In step S2510, because the user A has the authority for the page N, the bookbinding application 104 (the CPU 201) sets an image indicating the content of the page N as the preview image for the page N and then ends the processing for generating a preview image of the page N for the user A. Thereby, if it is determined in step S2508 that the user A has the authority (the viewing authority) for the page N (YES in step S2508), then the display of the page N which is a constituent of the document is not restricted.

The processing performed by the bookbinding application 104 using the viewing authority as the security setting is described above with reference to FIG. 25. In the case where the editing authority, the printing authority, or other authorities are used as the security setting, the processing described with reference to FIG. 25 can be similarly performed based on these authorities instead of the viewing authority. In this case, the reference destination at the time of setting the authority in steps S2505, S2506, and S2507 is used as the setting destination of the respective authority.

In the present exemplary embodiment, the security setting by the bookbinding application 104 (the CPU 201) can be performed to set at least one of the viewing authority, the printing authority, and the editing authority for each page. In this case, the bookbinding application 104 (the CPU 201) designates the user for whom the preview image is displayed based on the security setting from among the users listed in the preview user selection combo box. Furthermore, the bookbinding application 104 (the CPU 201) determines, with respect to each page, whether the designated user has the authority for displaying the content of the page as the preview image and displays the preview image based on the result of the determination.

### Third Exemplary Embodiment

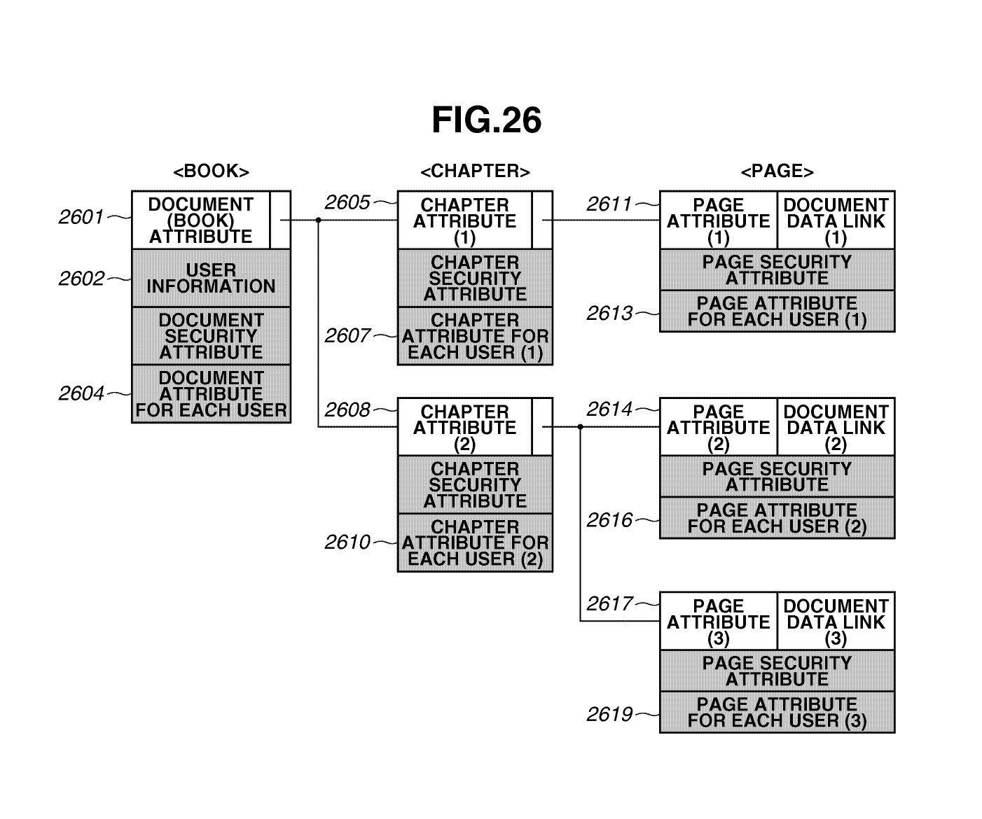

In a third exemplary embodiment, the configuration is the same as the second exemplary embodiment, except a format of the book file (FIG. 3A). The third exemplary embodiment of the present invention is described below with reference to FIG. 26.

FIG. 26 illustrates an example of another format of the book file according to the present exemplary embodiment. In the third exemplary embodiment, an attribute for each user can be set in addition to the format of the book file in FIG. 3A in the second exemplary embodiment.

Referring to FIG. 26, a document attribute for each user 2604 can be set for a book. Furthermore, a chapter attribute for each user (1) 2607 and a chapter attribute for each user (2) 2610 can be set for a chapter. Moreover, a page attribute for each user (1) 2613, a page attribute for each user (2) 2616, and a page attribute for each user (3) 2619 can be set for a page. The other portions of the configuration of the book file are the same as that illustrated in FIG. 3A.

With the file structure illustrated in FIG. 26, the present exemplary embodiment can set a print attribute relating to a print appearance for each user. Furthermore, as the print attribute in the case where no print attribute for each user is set, the present exemplary embodiment defines common print attributes. In FIG. 26, a document (book) attribute 2601, a chapter attribute (1) 2605, a chapter attribute (2) 2608, a page attribute (1) 2611, a page attribute (2) 2614, and a page attribute (3) 2617, are used as the common print attributes.

The present exemplary embodiment relates to a method for displaying a preview image based on the setting for each user in the case where the security setting for each user and the print attribute for each user is set for one book file.

In the present exemplary embodiment, a preview user selection combo box (for example, the preview user selection combo box 1701 in FIG. 17) for selecting a user for whom a preview is performed is added to the UI screen 1400 (FIG. 14) to display a preview of the book file opened by the bookbinding application 104 (the CPU 201). Thus, the user for whom a preview is performed can be selected.

As the user list displayed in the preview user selection combo box 1701, the list of the users in the user information 2602 registered in the opened book file is displayed. The processing for generating the user list is the same as the processing for generating the user list described with reference to FIG. 22. The user list can include not only the user name but also a list of user groups that include a plurality of users in a lump.

In addition, the user name and the user authority can be listed as in the case of the preview user selection combo box 1801 in the UI screen 1800 in FIG. 18 in the second exemplary embodiment. In this case, the bookbinding application 104 (the CPU 201) displays the preview based on the selected authority, contrary to the case of the example in FIG. 17 where the bookbinding application 104 (the CPU 201) displays the preview image based on the assumption that the user has the viewing authority.

As illustrated by the preview user selection combo box 1901 on the UI screen 1900 in FIG. 19, in the case where the “user A” is selected as the user for whom a preview is performed, a preview is displayed according to the authority of the user A. Processing for generating the preview display image is performed according to the processing in flow charts of FIGS. 27, 28, and 25.

By generating a preview display image as described above, the page for which the user A has the viewing authority is displayed as a preview in which the content can be recognized, as a page 1902 in FIG. 19. As a page 1903 in FIG. 19, the page for which the user A does not have the viewing authority is displayed as a preview in which the content cannot be recognized.

In generating a paper sheet preview image, if an attribute that concerns a page layout is set for a book, a chapter, or a page with respect to the user A selected via the preview user selection combo box 1901, then the page layout is generated based on the attribute. On the other hand, in generating a paper sheet preview image, if an attribute that concerns a page layout is not set for a book, a chapter, or a page with respect to the user A selected via the preview user selection combo box 1901, then the page layout is generated based on the common print attributes. In this case, the paper sheet preview image according to the authority of the selected user is displayed.

FIG. 20 illustrates an example UI screen displayed when an attribute for imposing four pages on one paper sheet is set and a preview is performed based on the authority of the user A, as described above.

Referring to FIG. 20, a preview image of a paper sheet 2002 includes a fifth, a sixth, a seventh, and an eighth pages. However, because the user A has the authority only for a first, the fifth, the sixth, and the seventh pages, the paper sheet 2002 is displayed as a preview image in which the content of the eighth page cannot be recognized. In the case where the user does not have any authority for all the pages to be printed on one output paper sheet, the paper sheet preview is displayed as a preview image in which the contents of all the pages to be printed on the output paper sheet cannot be recognized, as shown in the image of the paper sheet 2003 in FIG. 20.

In print processing, a paper sheet for which a user has no printing authority is printed according to the preview image in which the content cannot be recognized. However, the present exemplary embodiment can perform a setting that the paper sheet is not printed for which the user does not have a printing authority according to selection by the user.

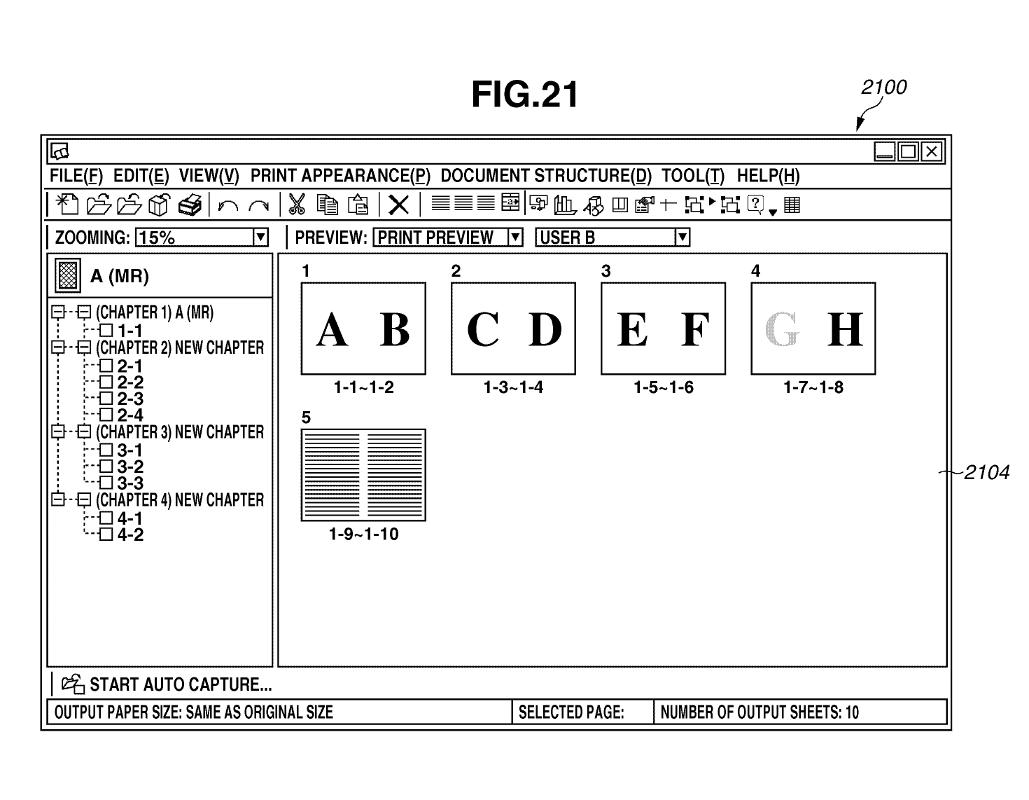

For example, suppose that a “user B” having the same security setting but different print attribute from that of the user A is set. In this case, if the user in the preview user selection combo box 1901 is changed from the user A to the user B, then the preview image is displayed in the preview portion 2104 based on the security setting and the print attribute for the user B, as shown in the UI screen 2100 in FIG. 21.

In addition, the present invention can be applied in the case where an operation similar to the present exemplary embodiment is performed by using a print attribute and information about a security setting stored in a security management server connected to the document management system via a network, instead of including the print attribute and the information related to the security setting within the file format, as in FIG. 26.

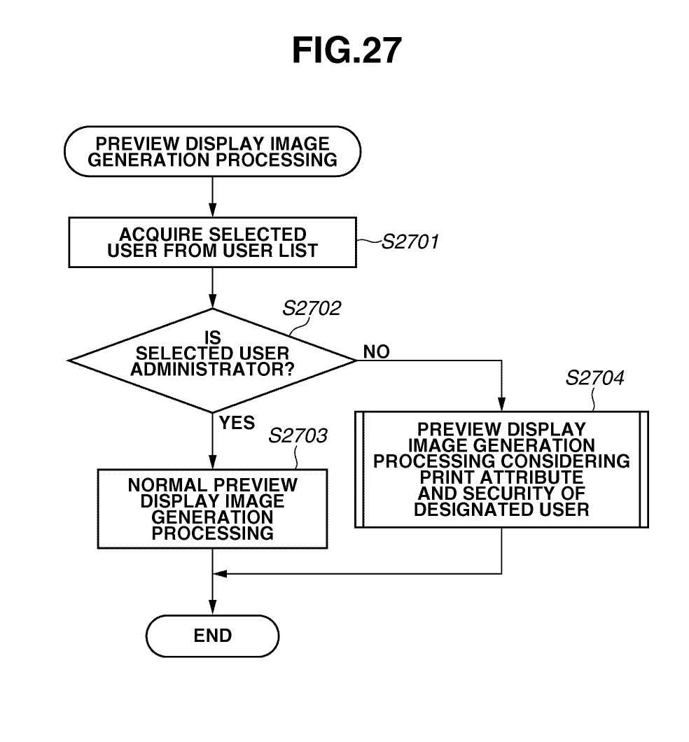

FIG. 27 is a flow chart illustrating an example of the processing for generating preview display image according to the third exemplary embodiment. The processing starts before the bookbinding application 104 (the CPU 201) opens a new book file and actually performs a preview or at the time the bookbinding application 104 (the CPU 201) generates a page preview image due to a change in a print attribute.

Referring to FIG. 27, in step S2701, the bookbinding application 104 (the CPU 201) acquires information about the user who is selected and designated via the preview user selection combo box.

In step S2702, the bookbinding application 104 (the CPU 201), based on the user information 302, determines whether the user whose user information 302 has been acquired in step S2701 is an administrator having an administrator authority.

If it is determined that the user whose user information 302 has been acquired in step S2701 is the administrator having the administrator authority (YES in step S2702), then the processing advances to step S2703. In step S2703, the bookbinding application 104 (the CPU 201) performs normal processing for generating preview display image for normally displaying all the page preview images and then completes the processing.

On the other hand, if it is determined that the user whose user information 302 has been acquired in step S2701 is not the administrator having the administrator authority (NO in step S2702), then the processing advances to step S2704. In step S2704, the bookbinding application 104 (the CPU 201), performs the processing for generating preview display image by reflecting the print attribute and the security setting for the designated user. The bookbinding application 104 then completes the processing.

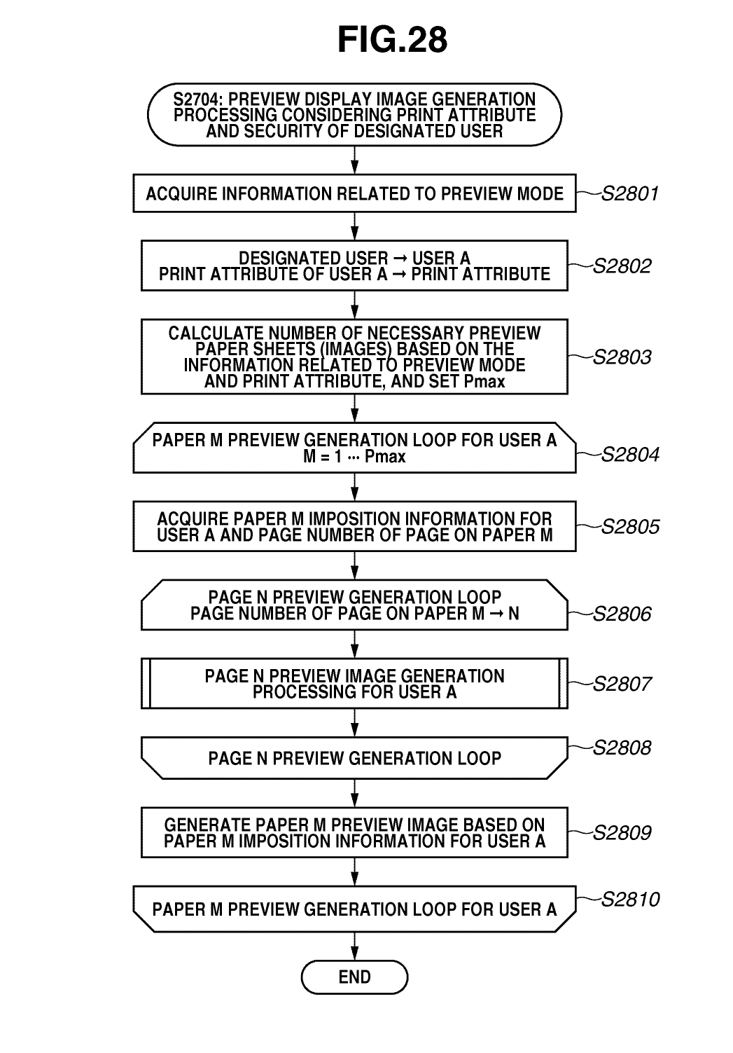

FIG. 28 is a flow chart illustrating an example of the processing for generating preview display image in step S2704 in FIG. 27 performed by reflecting the print attribute and the security setting for the designated user.

At the start of the processing in step S2704 in FIG. 27, in step S2801, the bookbinding application 104 (the CPU 201) acquires information about a preview mode, namely, information about the processing for generating preview display image in step S2704.

In step S2802, the bookbinding application 104 (the CPU 201) sets (stores) the user who is selected via the preview user selection combo box as the user A, acquires the print attribute for the user A, and sets (stores) the acquired print attribute for the user A as the print attribute.

In step S2803, the bookbinding application 104 (the CPU 201) calculates a number of necessary paper sheet preview display images (number of images) based on the information related to the preview mode acquired in step S2801 and the print attribute set in step S2802. The bookbinding application 104 then sets (stores) the calculated number of the necessary paper sheet display preview images (number of images) as a value Pmax.

In step S2804, the bookbinding application 104 (the CPU 201) sets a variable M indicating a paper sheet preview image to be generated. Thus, a paper sheet M corresponding to the paper sheet preview image to be generated is set and a loop for generating a preview image for the paper sheet M starts. In first processing, “1” is set to the paper sheet M.

In step S2805, the bookbinding application 104 (the CPU 201) acquires information about imposition on the paper sheet M to be generated and acquires page number(s) of page(s) to be imposed on the paper sheet M.

In step S2806, the bookbinding application 104 (the CPU 201) sets a variable N indicating a page preview image to be generated. Thus, a page N corresponding to the page preview image to be generated is set and a loop for generating a preview image for the page N on the paper sheet M starts. In first processing, a smallest page number of the acquired page numbers is set to the page N.

In step S2807, the bookbinding application 104 (the CPU 201) performs the processing for generating a preview image for the page N based on the authority of the user A. The detailed processing in step S2807 is the same as that described in the second exemplary embodiment with reference to FIG. 25. Then, the processing advances to step S2808.

In step S2808, the bookbinding application 104 (the CPU 201) determines whether processing for generating the preview image is completed for all the pages having the page number acquired in step S2805. If it is determined in step S2808 that a page whose processing for generating preview image is not performed yet exists in the pages having the page number acquired in step S2805, then the processing returns to step S2806. In step S2806, the bookbinding application 104 (the CPU 201) changes the page N to be generated. Then, the bookbinding application 104 (the CPU 201) repeats the processing in step S2807.

On the other hand, if it is determined in step S2808 that the processing for generating preview image is completed for all the pages having the page number acquired in step S2805, then the processing advances to step S2809. In step S2809, the bookbinding application 104 (the CPU 201) generates the preview image for the paper sheet M using the preview image of each page acquired in the loop in steps S2806 through S2808, information about the preview mode for the paper sheet M, and the print attribute.

In step S2810, the bookbinding application 104 (the CPU 201) determines whether processing for generating the preview image is completed for all the paper sheets having the value Pmax set in step S2803. If it is determined in step S2810 that a page whose processing for generating preview image is not completed exists, then the processing returns to step S2804. In step S2804, the bookbinding application 104 (the CPU 201) increments the paper sheet M to be generated by one and performs the setting for changing the paper sheet M to be generated. Then, the bookbinding application 104 (the CPU 201) repeats the processing in step S2805 and subsequent steps.

On the other hand, if it is determined in step S2810 that the processing for generating preview image is completed for all the paper sheets having the value Pmax set in step S2803, then the bookbinding application 104 (the CPU 201) generates a preview display image reflecting the print attribute and the security setting for the designated user, the generation based on all the generated paper sheet preview image. Then, the processing in the flow chart of FIG. 28 ends.

The document management system according to the present exemplary embodiment of the present invention performs a security setting for each user with respect to each page (a constituent) constituting a book file (document). Furthermore, the present exemplary embodiment designates a user for whom a preview image generated based on the security setting is to be displayed, and the embodiment then determines, for each page, whether the designated user has the authority for displaying the content of the page as the preview image. Moreover, with respect to the page for which the user has no authority based on the result of the determination, the present exemplary embodiment displays a dummy image in which the content cannot be recognized as a preview image.

According to the present exemplary embodiment having the above-described configuration, the status of the security setting of each user set for each page constituting a document can be readily verified. Thus, the present exemplary embodiment enables an efficient management of a document.

### Other Exemplary Embodiments

Each step of the processing in FIGS. 9 through 12, FIGS. 22 through 25, FIG. 27, and FIG. 28, which illustrate the document management method performed by the document management apparatus according to the exemplary embodiments of the present invention, can be implemented by the program stored and operating on the program ROM 203b or the HD 211 (FIG. 2).

The program and a computer-readable storage medium (recording medium) storing the above-described program (and the program code of the program) constitute embodiments of the present invention.

More specifically, the program can be recorded on a storage medium such as a compact disk-read only memory (CD-ROM) or transmitted via various transmission (communication) media to be supplied to a computer. As the storage medium for storing such program code, a floppy disk, a hard disk, a magnetic tape, a magneto-optical disk (MO), a nonvolatile memory card, for example, can be used.

Furthermore, as the transmission (communication) media for transmitting the program, a communication medium in a computer network (a local area network (LAN), a wide area network (WAN) such as the Internet, or a wireless communication network) for transmitting and supplying program code as a carrier wave of program information can be used. As the communication medium, a wired communication using an optical fiber or a wireless communication line can be used.

In addition, the functions of the document management apparatus according to the exemplary embodiments of the present invention can be implemented not only by executing the program code supplied to the computer but alternatively by processing in which such a program operates in combination with an OS or other application software programs operating on the computer to carry out the actual processing based on an instruction given by the program code.

Furthermore, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the document management apparatus described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-155674 filed Jun. 12, 2007, which is hereby incorporated by reference herein in its entirety.

What is claimed is:

1. A document management apparatus configured to display a preview image of a document in which a plurality of constituents is defined, the document management apparatus comprising:
a setting unit configured to set an authority for each user with respect to each constituent;
a display unit configured to display on a display device a content of at least one constituent as a preview image;
a designation unit configured to designate a user for whom the preview image is displayed from among users whose authority is set by the setting unit; and
a determination unit configured to determine whether the user designated by the designation unit has an authority to display the content of the at least one constituent; wherein
the display unit restricts display of a first portion of the content corresponding to each constituent for which the user is determined to have no authority by the determination unit and displays a second portion of the content corresponding to each constituent for which the user is determined to have the authority by the determination unit.

2. The document management apparatus according to claim 1, wherein the display unit, as a restriction of the display of a constituent for which the user is determined to have no authority by the determination unit, displays as a preview image a dummy image in which content corresponding to that constituent cannot be recognized by the user.

3. The document management apparatus according to claim 1, wherein at least one constituent is a page constituting the document.

4. The document management apparatus according to claim 1, wherein the setting unit, in setting the authority, sets at least one of a viewing authority, a printing authority, and an editing authority to each constituent, and
wherein the determination unit performs the determination based on the authority set by the setting unit.

5. The document management apparatus according to claim 1, wherein the setting unit can set the authority not only for individual users but also for a user group including a plurality of users.

6. The document management apparatus according to claim 1, further comprising a listing unit configured to list users for whom the authority is set by the setting unit, wherein the designation unit specifies a user for whom the preview image is displayed based on the set authority from among the users listed by the listing unit.

7. The document management apparatus according to claim 6, wherein the listing unit can list the designated users instead of listing all users for whom the authority is set by the setting unit.

8. The document management apparatus according to claim 6, wherein the listing unit can list the users for each type of the set authority.

9. The document management apparatus according to claim 1, wherein the setting unit can store information about the set authority in a server connected to the document management apparatus via a network.

10. The document management apparatus according to claim 1, wherein the display unit further displays a content to be printed on an output paper sheet used in print processing as the preview image.

11. The document management apparatus according to claim 10, wherein a constituent for which the user is determined to have no authority by the determination unit or the output paper sheet including a constituent for which the user is determined to have no authority by the determination unit cannot be printed out.

12. The document management apparatus according to claim 1, wherein the setting unit further performs a setting related to a print appearance for the user, and
wherein the display unit can display the preview image based on the setting related to the print appearance.

13. A method for displaying a preview image of a document in which a plurality of constituents is defined, the method comprising:
setting an authority for each user with respect to each constituent;
displaying on a display device a content of at least one constituent as a preview image;
designating a user for whom the preview image is displayed from among users whose authority is set;
determining whether the designated user has an authority to display the content of the at least one constituent; and
restricting display of a first portion of the content corresponding to each constituent for which the user is determined to have no authority and displaying a second portion of the content corresponding to each constituent for which the user is determined to have the authority.

14. The method according to claim 13, further comprising displaying as a preview image a dummy image in which content of a constituent, for which the user is determined to have no authority, cannot be recognized by the user.

15. The method according to claim 13, wherein at least one constituent is a page constituting the document.

16. The method according to claim 13, further comprising:
setting, in setting the authority, at least one of a viewing authority, a printing authority, and an editing authority on each constituent; and
performing the determination based on the set authority.

17. The method according to claim 13, further comprising setting the authority not only for individual users but also for a user group including a plurality of users.

18. The method according to claim 13, further comprising:
listing users for whom the authority is set; and
designating a user for whom the preview image is displayed based on the set authority from among the users listed.

19. The method according to claim 18, further comprising listing the designated users instead of listing all users for whom the authority is set.

20. The method according to claim 18, further comprising listing the users for each type of the set authority.

21. The method according to claim 13, further comprising storing information about the set authority in a server connected to the document management apparatus via a network.

22. The method according to claim 13, further comprising displaying a content to be printed on an output paper sheet used in print processing as the preview image.

23. The method according to claim 22, wherein a constituent for which the user is determined to have no authority or the output paper sheet including a constituent for which the user is determined to have no authority cannot be printed out.

24. The method according to claim 13, further comprising:
performing a setting related to a print appearance for the user; and
displaying the preview image based on the setting related to the print appearance.

25. A computer-readable storage medium storing instructions for causing a computer to execute a method for displaying a preview image of a document in which a plurality of constituents is defined, the method comprising:
setting an authority for each user with respect to each constituent;
displaying on a display device a content of at least one constituent as a preview image;
designating a user for whom the preview image is displayed from among users whose authority is set;
determining whether the designated user has an authority to display the content of the at least one constituent; and
restricting display of a first portion of the content corresponding to each constituent for which the user is determined to have no authority and displaying a second portion of the content corresponding to each constituent for which the user is determined to have the authority.
